(19) United States
(12) Patent Application Publication
(10) Pub. No.: US 2019/0071116 A1
(43) Pub. Date: Mar. 7, 2019

(54) CONTROL APPARATUS FOR POWER STEERING APPARATUS AND POWER STEERING APPARATUS

(71) Applicant: HITACHI AUTOMOTIVE SYSTEMS, LTD., Hitachinaka-shi, Ibaraki (JP)

(72) Inventors: Mitsuo SASAKI, Hadano-shi, Kanagawa (JP); Takumi HISAZUMI, Atsugi-shi, Kanagawa (JP); Kazutoshi TANABE, Yokohama-shi, Kanagawa (JP)

(73) Assignee: HITACHI AUTOMOTIVE SYSTEMS, LTD., Hitachinaka-shi, Ibaraki (JP)

(21) Appl. No.: 16/091,914

(22) PCT Filed: Mar. 13, 2017
(86) PCT No.: PCT/JP2017/009900

§ 371 Date: Oct. 5, 2018

(30) Foreign Application Priority Data
Apr. 8, 2016 (JP) 2016-077856

(51) Int. Cl. B62D 5/04

(52) U.S. Cl. CPC B62D 5/0463; B62D 5/049

(57) ABSTRACT

Provided is a control apparatus for a power steering apparatus and a power steering apparatus capable of gradually increasing a steering reaction force felt by a driver since after a start of assist limitation when imposing the assist limitation for reducing power to be supplied to an electric motor that provides a steering force. A control apparatus for a power steering apparatus configured to provide a steering force to a steering mechanism with use of an electric motor includes an instruction signal calculation portion having characteristic information that increases an instruction signal for driving and controlling the electric motor as a steering torque increases, a characteristic information correction portion configured to correct the characteristic information in such a manner that the instruction signal gradually reduces according to reception of an assist limitation instruction signal, and a drive power supply portion configured to supply drive power to the electric motor based on the instruction signal.

### TECHNICAL FIELD

The present invention relates to a control apparatus for a power steering apparatus and a power steering apparatus.

### BACKGROUND ART

As this kind of technique, there is disclosed a technique discussed in the following patent literature, PTL 1. PTL 1 discloses a technique that sets an assist limit limiting an assist torque to be provided by a power steering apparatus according to a portion where an abnormality has occurred in a system.

### CITATION LIST

### Patent Literature

[PTL 1] Japanese Patent Application Public Disclosure No. 2010-221771

### SUMMARY OF INVENTION

### Technical Problem

The technique discussed in PTL 1 limits an upper limit value on the assist torque by the assist limit. When a vehicle runs normally, the provided assist torque is relatively small and may not reach the upper limit value limited by the assist limit. At this time, a driver can steer the vehicle in a usual manner, and therefore cannot recognize that the abnormality has occurred in the system.

The assist limit is set so as to further limit the assist torque as the number of abnormal portions in the system increases. When the limitation on the assist torque increases, the assist torque reaches the upper limit value limited by the assist limit even while the vehicle is running normally, so that the driver can feel that a steering reaction force increases, thereby recognizing that the abnormality has occurred in the system. However, the driver feels that the steering reaction force suddenly increases, and therefore the steering is largely affected.

An object of the present invention is to provide a control apparatus for a power steering apparatus and a power steering apparatus capable of gradually increasing the steering reaction force felt by the driver since after a start of the assist limitation when imposing the assist limitation that reduces power to be supplied to an electric motor that provides a steering force.

### Solution to Problem

To achieve the above-described object, according to a first aspect of the present invention, provided is a control apparatus for a power steering apparatus configured to provide a steering force to a steering mechanism with use of an electric motor. The control apparatus includes an instruction signal calculation portion having characteristic information that increases an instruction signal for driving and controlling the electric motor as a steering torque increases, a characteristic information correction portion configured to correct the characteristic information in such a manner that the instruction signal gradually reduces according to reception of an assist limitation instruction signal, and a drive power supply portion configured to supply drive power to the electric motor based on the instruction signal.

According to a second aspect of the present invention, provided is a power steering apparatus configured to provide a steering force to a steering mechanism with use of an electric motor. The power steering apparatus includes a controller. The controller includes an instruction signal calculation portion having characteristic information that increases an instruction signal for driving and controlling the electric motor as a steering torque increases, a characteristic information correction portion configured to correct the characteristic information in such a manner that the instruction signal gradually reduces according to reception of an assist limitation instruction signal, and a drive power supply portion configured to supply drive power to the electric motor based on the instruction signal.

Therefore, the steering reaction force felt by the driver can be gradually increased since after the start of the assist limitation.

### BRIEF DESCRIPTION OF DRAWINGS

FIG. 1 is a perspective view of a power steering apparatus according to a first embodiment.

FIG. 2 is a cross-sectional view of the power steering apparatus according to the first embodiment taken along an axis of a wheel turning shaft.

FIG. 3 is a schematic view of the power steering apparatus according to the first embodiment.

FIG. 4 is a block diagram of an electric system according to the first embodiment.

FIG. 5 is a block diagram of sensors according to the first embodiment.

FIG. 6 is a control block diagram according to the first embodiment.

FIG. 7 is a graph indicating a motor instruction current map according to the first embodiment.

FIG. 8 is a flowchart illustrating a flow of processing performed by an electronic control unit at the time of a sensor abnormality according to the first embodiment.

FIG. 9 is a flowchart illustrating a flow of processing for gradually reducing an assist torque according to the first embodiment.

FIG. 10 is a flowchart illustrating a flow of Limp Home processing A according to the first embodiment.

FIG. 11 is a flowchart illustrating a flow of Limp Home processing B according to the first embodiment.

FIG. 12 illustrates timing charts during the processing for gradually reducing the assist torque according to the first embodiment.

FIG. 13 illustrates a target assist torque map according to the first embodiment.

FIG. 14 illustrates the target assist torque map according to the first embodiment.

FIG. 15 illustrates the target assist torque map according to the first embodiment.

FIG. 16 illustrates the target assist torque map according to the first embodiment.

FIG. 17 illustrates timing charts during the Limp Home processing A according to the first embodiment.

FIG. 18 illustrates the target assist torque map according to the first embodiment.

FIG. 19 illustrates the target assist torque map according to the first embodiment.

FIG. 20 illustrates the target assist torque map according to the first embodiment.

FIG. 21 illustrates the target assist torque map according to the first embodiment.

FIG. 22 illustrates timing charts during the Limp Home processing B according to the first embodiment.

FIG. 23 illustrates the target assist torque map according to the first embodiment.

FIG. 24 illustrates the target assist torque map according to the first embodiment.

FIG. 25 illustrates the target assist torque map according to the first embodiment.

FIG. 26 illustrates the target assist torque map according to the first embodiment.

### DESCRIPTION OF EMBODIMENTS

### First Embodiment

A power steering apparatus 1 according to a first embodiment will be described. The power steering apparatus 1 according to the first embodiment functions to provide an assist torque to a steering torque generated according to steering by a driver by transmitting a drive force of an electric motor 40 to a wheel turning shaft 10 via a ball screw mechanism 26 (assist control).

[Configuration of Power Steering Apparatus]

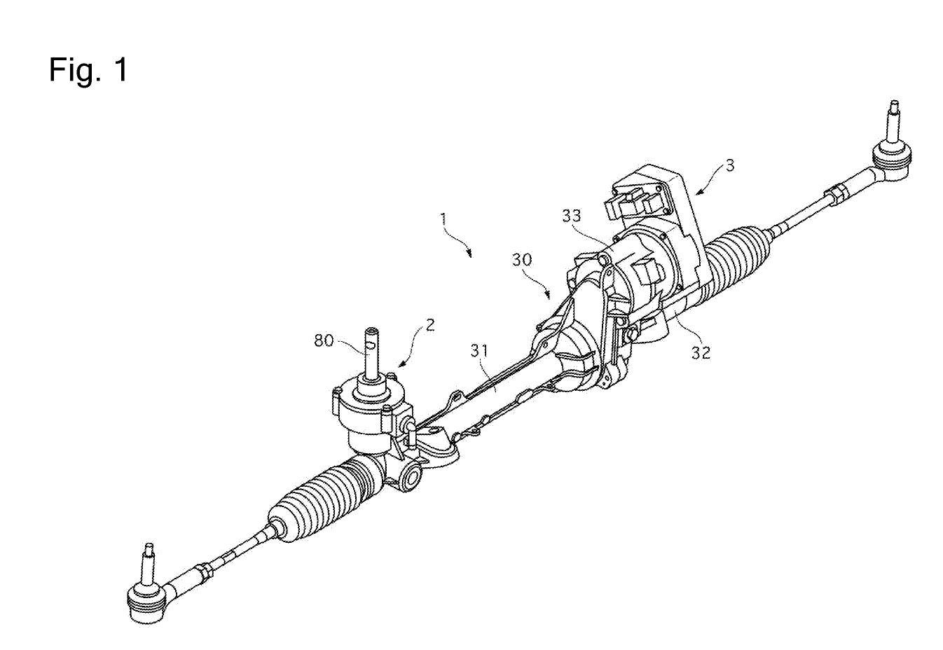

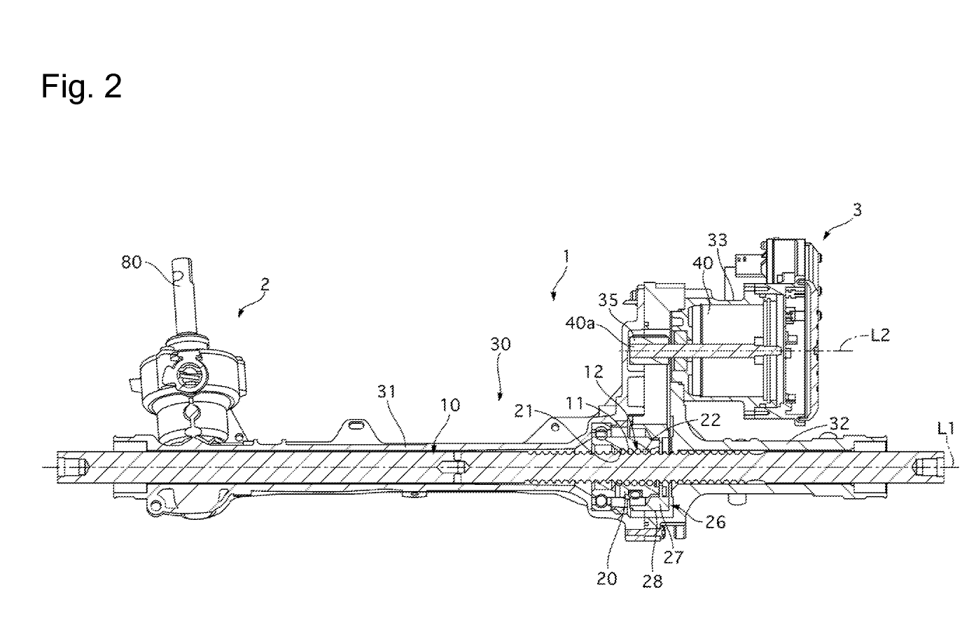

FIG. 1 is a perspective view of the power steering apparatus 1. FIG. 2 is a cross-sectional view of the power steering apparatus 1 taken along an axis of the wheel turning shaft 10.

The power steering apparatus 1 includes a steering mechanism 2 and an assist mechanism 3. The steering mechanism 2 transmits a rotation of a steering wheel steered by the driver to the wheel turning shaft 10, which then turns a turning target wheel. The assist mechanism 3 provides the torque to the wheel turning shaft 10.

Each of components of the power steering apparatus 1 is contained in a housing 30, which includes a first housing 31, a second housing 32, and a motor housing 33.

The steering mechanism 2 includes a steering input shaft 80 coupled to the steering wheel. A pinion 81 is formed at a distal end of the steering input shaft 80. The pinion 81 is meshed with a rack formed on an outer periphery of the wheel turning shaft 10.

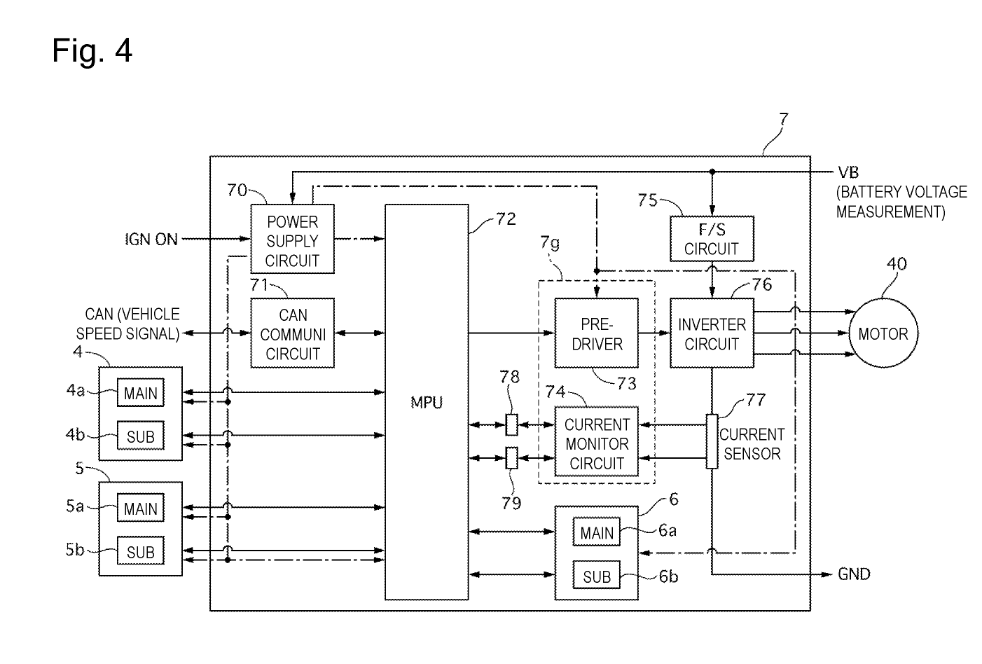

The assist mechanism 3 includes the electric motor 40 and the ball screw mechanism 26. The ball screw mechanism 26 transmits an output of the electric motor 40 to the wheel turning shaft 10. The output of the electric motor 40 is controlled by an electronic control unit 7 according to the steering torque and a steering amount inputted by the driver onto the steering wheel (FIGS. 4, 5, and 6).

The ball screw mechanism 26 includes a nut 20 and an output pulley 27. An external appearance of the output pulley 27 is a cylindrical member, and is fixed to the nut 20 integrally rotatably. A cylindrical input pulley 35 is fixed to a drive shaft 40a of the electric motor 40 integrally rotatably. A first reference axis L1 and a second reference axis L2 are defined to be a rotational axis of the nut 20, and a rotational axis of the input pulley 35, respectively. The second reference axis L2 is positioned so as to be radially offset from the first reference axis L1. The output pulley 27, which is integrally fixed to the nut 20, also has a rotational axis coinciding with the first reference axis L1.

A belt 28 is wound between the input pulley 35 and the output pulley 27. The belt 28 is made from resin. The drive force of the electric motor 40 is transmitted to the nut 20 via the input pulley 35, the belt 28, and the output pulley 27. The input pulley 35 is formed in such a manner that an outer diameter thereof is smaller than an outer diameter of the output pulley 27. A speed reducer is formed by the input pulley 35, the output pulley 27, and the belt 28.

The nut 20 is cylindrically formed so as to surround the wheel turning shaft 10, and is provided rotatably with respect to the wheel turning shaft 10. A groove is helically formed on an inner periphery of the nut 20, and this groove forms a nut-side ball screw groove 21. A helical groove is formed on an outer periphery of the wheel turning shaft 10 at a position axially away from a portion where the rack is formed, and this groove forms a wheel turning shaft-side ball screw groove 11.

A ball circulation groove 12 is formed by the nut-side ball screw groove 21 and the wheel turning shaft-side ball screw groove 11 with the wheel turning shaft 10 inserted in the nut 20. A plurality of metallic balls 22 is loaded in the ball circulation groove 12. When the nut 20 rotates, the balls 22 move in the ball circulation groove 12, which causes the wheel turning shaft 10 to move longitudinally with respect to the nut 20.

[Regarding Various Kinds of Sensors]

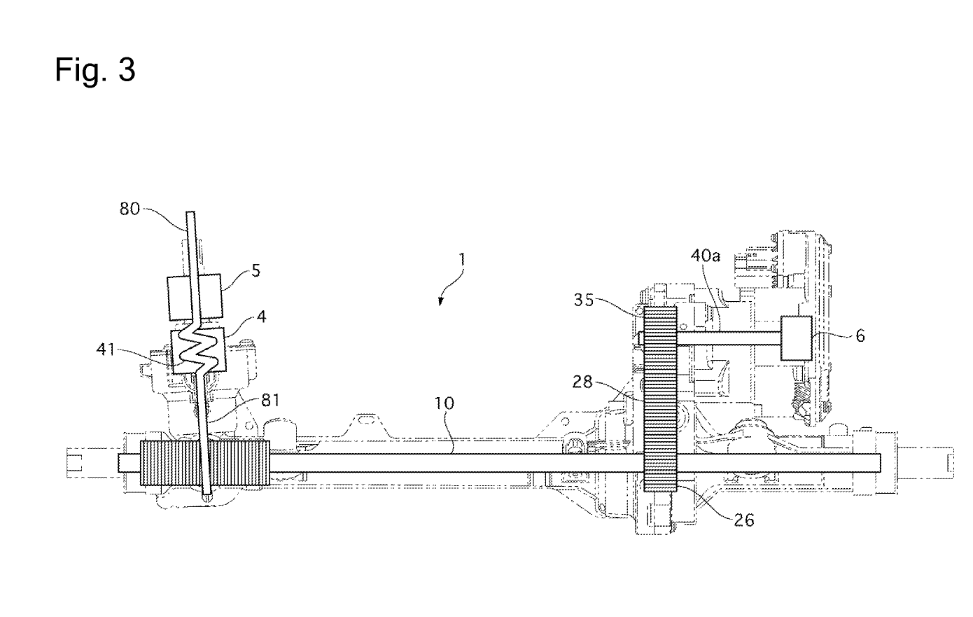

FIG. 3 is a schematic view of the power steering apparatus 1.

The power steering apparatus 1 includes a steering torque sensor 4, a steering angle sensor 5, and a motor rotational angle sensor 6. The steering torque sensor 4 detects the steering torque inputted by the driver onto the steering wheel. The steering angle sensor 5 detects a steering angle of the steering wheel. The rotational angle sensor 6 detects a rotational angle of a rotor of the electric motor 40.

The steering torque sensor 4 detects the steering torque based on a torsional amount of a torsion bar 41 provided between the steering input shaft 80 and the pinion 81. The torsional amount of the torsion bar 41 can be acquired from a difference between a rotational angle of the steering input shaft 80 and a rotational angle of the pinion 81. Assuming that the rotational angles of the steering input shaft 80 and the pinion 81 are θs [deg.] and θp [deg.], respectively, the steering torque Ts can be acquired from the following equation.

Ts=Ktb(θs−θp)

The steering angle sensor 5 detects the rotational angle of the steering input shaft 80 as the steering angle. The steering angle sensor 5 is provided on a steering wheel side with respect to the torsion bar 41.

The steering torque can be acquired from a detection value of the steering angle sensor 5 and a detection value of the motor rotational angle sensor 6. The rotational angle θs [deg.] of the steering input shaft 80 can be acquired by using the detection value of the steering angle sensor 5. The rotational angle θp [deg.] of the pinion 81 can be acquired from the following equation with use of a rotational angle θm [deg.] of the rotor of the electric motor 40 and a speed reduction rate Ng from the pinion 81 to the drive shaft 40a of the electric motor 40.

θp=Ng×θm

[Block Diagram of Electric System]

FIG. 4 is a block diagram of an electric system.

The steering torque sensor 4 includes two sensors, a main steering torque sensor 4a and a sub steering torque sensor 4b. The steering angle sensor 5 includes two sensors, a main steering angle sensor 5a and a sub steering angle sensor 5b. The motor rotational angle sensor 6 includes two sensors, a main motor rotational angle sensor 6a and a sub motor rotational angle sensor 6b. The motor rotational angle sensor 6 is built in the electronic control unit 7.

The electronic control unit 7 includes a power supply circuit 70, a CAN communication circuit 71, a microprocessor 72, a pre-driver 73, a current monitor circuit 74, a fail-safe circuit 75, an inverter circuit 76, a current sensor 77, a first current detection circuit 78, and a second current detection circuit 79.

When an ignition switch is switched on, the power supply circuit 70 supplies power from a battery to the steering torque sensor 4, the steering angle sensor 5, the motor rotational angle sensor 6, the microprocessor 72, and the pre-driver 73.

The CAN communication circuit 71 exchanges a signal with a controller area network (Controller Area Network: CAN).

The microprocessor 72 receives inputs of vehicle speed information of the vehicle itself from the CAN communication circuit 71, steering torque information from the steering torque sensor 4, steering angle information from the steering angle sensor 5, motor rotational angle information from the motor rotational angle sensor 6, and current value information from the first current detection circuit 78 and the second current detection circuit 79. The microprocessor 72 calculates a motor instruction current to be output from the electric motor 40 based on the input information, and outputs the calculated motor instruction current to the pre-driver 73.

The pre-driver 73 generates a PWM duty signal that controls the inverter circuit 76 based on the motor instruction current calculated by the microprocessor 72, and outputs the generated PWM duty signal to the inverter circuit 76.

The current monitor circuit 74 receives an input of a detection value of the current sensor 77, which detects a current flowing in the inverter circuit 76. The current monitor circuit 74 monitors whether a current value required for the control of the electric motor 40 is output as targeted so as to output the assist torque calculated by the microprocessor 72. A motor control circuit 7g is formed by the pre-driver 73 and the current monitor circuit 74.

When the microprocessor 72 detects an abnormality in the system and determines to shut down the system, the fail-safe circuit 75 stops the power supply from the inverter circuit 76 to the electric motor 40 based on an instruction from the microprocessor 72.

The inverter circuit 76 includes a drive element for supplying the current to the electric motor 40. The inverter circuit 76 supplies a drive current to the electric motor 40 based on an instruction from the pre-driver 73.

The first current detection circuit 78 performs highly responsive filter processing on the current value inputted to the current monitor circuit 74, and outputs a result thereof to the microprocessor 72. The second current detection circuit 79 performs low responsive filter processing on the current value inputted to the current monitor circuit 74, and outputs a result thereof to the microprocessor 72. The current value processed by the highly responsive filter processing is used to control the electric motor 40. The current value processed by the low responsive filter processing results in an average current value and is used to monitor an eddy current of the inverter circuit 76.

[Block Diagram of Sensors]

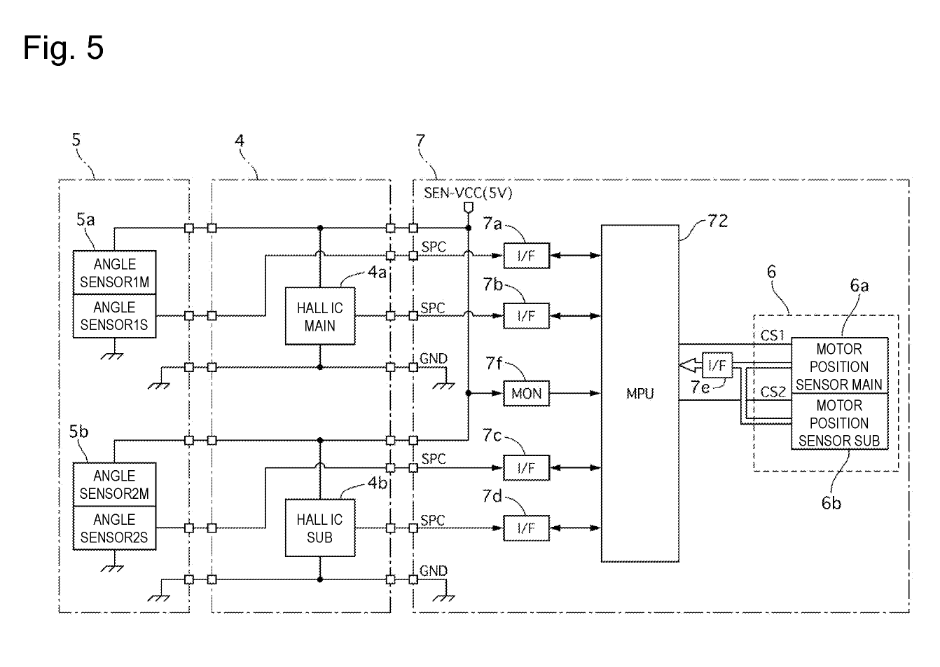

FIG. 5 is a block diagram of the sensors.

The main steering torque sensor 4a is connected to the microprocessor 72 via a main steering torque signal reception portion 7b provided in the electronic control unit 7. The sub steering torque sensor 4b is connected to the microprocessor 72 via a sub steering torque signal reception portion 7d provided in the electronic control unit 7. The main steering angle sensor 5a is connected to the microprocessor 72 via a main steering angle signal reception portion 7a provided in the electronic control unit 7. The sub steering angle sensor 5b is connected to the microprocessor 72 via a sub steering angle signal reception portion 7c provided in the electronic control unit 7. The main motor rotational angle sensor 6a and the sub motor rotational angle sensor 6b are connected to the microprocessor 72 via a motor rotational angle signal reception portion 7e provided in the electronic control unit 7.

The main steering torque sensor 4a, the sub steering torque sensor 4b, the main steering angle sensor 5a, and the sub steering angle sensor 5b are connected to an abnormality detection circuit 7f provided in the electronic control unit 7. The abnormality detection circuit 7f monitors an abnormality in each of the sensors, and, upon occurrence of an abnormality in a sensor, outputs information about the sensor where the abnormality has occurred to the microprocessor 72.

Each of the signal reception portions is realized with use of an interface of the microprocessor 72 in the first embodiment, but may be configured to be realized by software.

[Control Block Diagram]

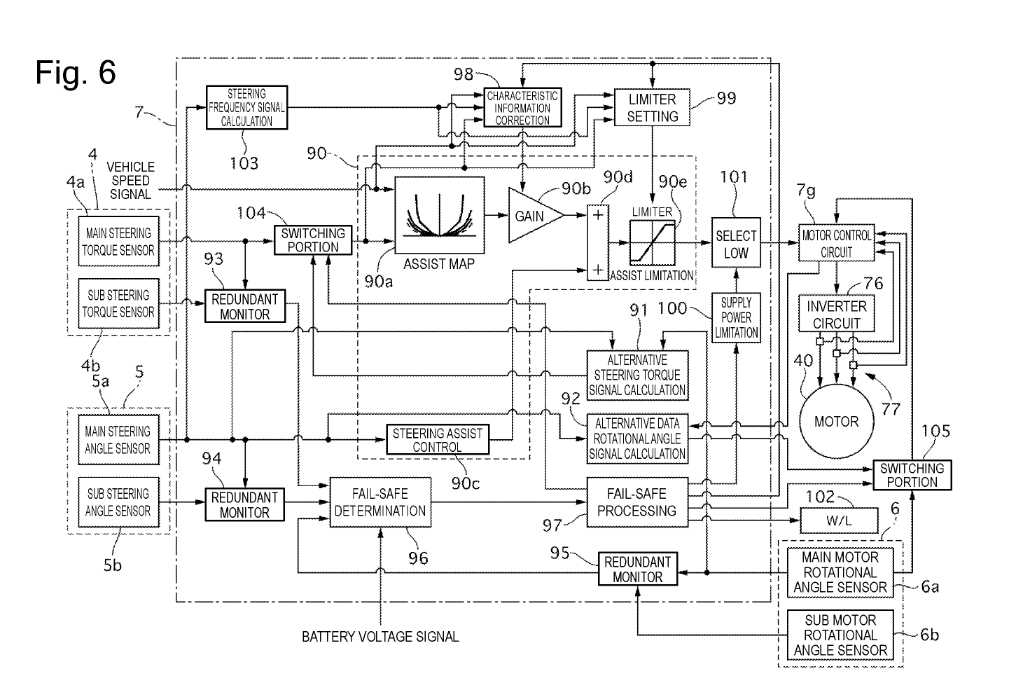

FIG. 6 is a control block diagram.

The electronic control unit 7 includes a motor instruction current calculation portion 90, an alternative steering torque signal calculation portion 91, an alternative motor rotational angle signal calculation portion 92, a steering torque sensor redundant monitor portion 93, a steering angle sensor redundant monitor portion 94, a motor rotational angle sensor redundant monitor portion 95, a fail-safe determination portion 96, a fail-safe processing portion 97, a characteristic information correction portion 98, a limiter setting portion 99, and a supply power limitation portion 100.

The power steering apparatus 1 realizes each configuration in the electronic control unit 7 by software in the first embodiment, but may be configured to realize it by an electronic circuit. Further, a calculation carried out in each configuration refers to not only a calculation of an equation but also all kinds of processing on software.

The motor instruction current calculation portion 90 includes a motor instruction current map 90a, a gain 90b, a steering assist control portion 90c, an addition portion 90d, and a limiter 90e.

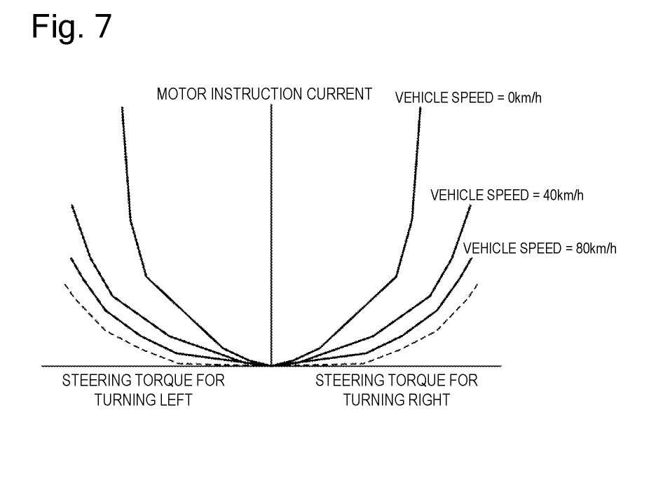

The motor instruction current map 90a receives inputs of the steering torque signal and the vehicle speed signal, and calculates the motor instruction current from the inputted information. FIG. 7 is a graph indicating the motor instruction current map 90a. The motor instruction current map 90a is a map for acquiring the motor instruction current from the steering torque. The motor instruction current is set so as to increase as the steering torque increases. Further, the motor instruction current is set so as to reduce as the vehicle speed increases. The motor instruction current map 90a includes the map illustrated in FIG. 7 in the first embodiment, but the motor instruction current may be acquired by calculating it without using the map.

An output torque of the electric motor 40 is transmitted to the wheel turning shaft 10 via the ball screw mechanism 26. This results in a reduction in the steering torque that the driver has to input, and a torque equivalent to this reduction will be hereinafter referred to as an assist torque. Further, hereinafter, the assist torque when the electric motor 40 is controlled according to the motor instruction current acquired by the motor instruction current map 90a will be referred to as a target assist torque.

In the power steering apparatus 1 according to the first embodiment, the electric motor 40 is controlled based on the torque. In other words, the motor instruction current is highly correlated with the target assist torque, and is approximately proportional thereto.

The gain 90b multiplies the motor instruction current acquired by the motor instruction current map 90a by a gain. The gain is a numerical value equal to or smaller than 1, and is set by the characteristic information correction portion 98. The gain 90b may operate so as to multiply the entire data in the motor instruction current map 90a by the gain.

The characteristic information correction portion 98 receives inputs of the vehicle speed signal, the steering torque signal, and the steering frequency signal. The characteristic information correction portion 98 sets the gain based on processing instructed by the fail-safe processing portion 97.

The steering frequency signal is calculated by a steering frequency signal calculation portion 103 according to the steering speed acquired from the steering angle signal. For example, the steering frequency signal calculation portion 103 counts the number of times that a direction of the steering speed is switched (when the steering operation is switched from additionally steering the steering wheel to returning the steered steering wheel or returning the steered steering wheel to additionally steering the steering wheel), and outputs the number of times counted within a predetermined time period as the steering frequency signal.

The steering assist control portion 90c receives an input of the steering angle signal, and calculates the motor instruction current for providing the assist torque when the steering wheel is steered in a return direction based on the input information (return control).

The addition portion 90d adds an output value of the gain 90b and an output value of the steering assist control portion 90c, and outputs a result thereof as the motor instruction current.

The limiter 90e receives an input of the motor instruction current of the addition portion 90d. When the inputted motor instruction current exceeds the set upper limit value, the limiter 90e outputs this upper limit value as the motor instruction current. The upper limit value is set by the limiter setting portion 99.

The limiter setting portion 99 receives inputs of the vehicle speed signal, the steering torque signal, and the steering frequency signal. The limiter setting portion 99 sets the upper limit value in the limiter 90e based on processing instructed by the fail-safe processing portion 97.

The alternative steering torque signal calculation portion 91 receives inputs of the steering angle signal of the main steering angle sensor 5a and the motor rotational angle signal of the main motor rotational angle sensor 6a. The alternative steering torque signal calculation portion 91 calculates the rotational angle of the pinion 81 (a pinion rotational angle) from the motor rotational angle signal. The pinion rotational angle can be acquired from the speed reduction rate from the drive shaft 40a of the electric motor 40 to the pinion 81, and the motor rotational angle. The alternative steering torque signal calculation portion 91 calculates the steering torque from the steering angle signal and the calculated pinion rotational angle, and outputs a result thereof as the alternative steering torque signal.

The alternative motor rotational angle signal calculation portion 92 receives inputs of the steering angle signal of the main steering angle sensor 5a and the control signal of the inverter circuit 76 of the motor control circuit 7g. The alternative motor rotational angle signal calculation portion 92 calculates the motor rotational angle from the steering angle signal. The motor rotational angle can be acquired from the speed reduction rate from the steering input shaft 80 to the electric motor 40, and the steering angle. The alternative motor rotational angle signal calculation portion 92 outputs the calculated motor rotational angle as the alternative motor rotational angle signal.

The steering torque sensor redundant monitor portion 93 compares the output value of the main steering torque sensor 4a and the output value of the sub steering torque sensor 4b, and determines that an abnormality has occurred in the steering torque sensor 4 when a difference between the output values is larger than a predetermined value.

The steering angle sensor redundant monitor portion 94 compares the output value of the main steering angle sensor 5a and the output value of the sub steering angle sensor 5b, and determines that an abnormality has occurred in the steering angle sensor 5 when a difference between the output values is larger than a predetermined value.

The motor rotational angle sensor redundant monitor portion 95 compares the output value of the main motor rotational angle sensor 6a and the output value of the sub motor rotational angle sensor 6b, and determines that an abnormality has occurred in the motor rotational angle sensor 6 when a difference between the output values is larger than a predetermined value.

The electronic control unit 7 determines the occurrence of the abnormality in the sensor by comparing the respective output values of the sensors with use of the steering torque sensor redundant monitor portion 93, the steering angle sensor redundant monitor portion 94, and the motor rotational angle sensor redundant monitor portion 95, and therefore can reduce a processing load imposed on the microprocessor 72.

The fail-safe determination portion 96 receives inputs of signals of the steering torque sensor redundant monitor portion 93, the steering angle sensor redundant monitor portion 94, and the motor rotational angle sensor redundant monitor portion 95, and determines whether to perform fail-safe processing according to the sensor where the abnormality has occurred. Further, the fail-safe determination portion 96 receives an input of a battery voltage signal, and monitors a battery voltage.

The fail-safe processing portion 97 performs the fail-safe processing according to the sensor where the abnormality has occurred when the fail-safe determination portion 96 determines to perform the fail-safe processing.

More specifically, when the abnormality has occurred in the steering torque sensor 4, the fail-safe processing portion 97 outputs an instruction to a switching portion 104, thereby outputting the alternative steering torque signal as the steering torque signal in place of the steering torque signal detected by the main steering torque sensor 4a. Further, when the abnormality has occurred in the motor rotational angle sensor 6, the fail-safe processing portion 97 outputs an instruction to a switching portion 105, thereby outputting an alternative motor rotational angle signal as the motor rotational angle signal in place of the motor rotational angle signal detected by the main motor rotational angle sensor 6a.

Further, when the abnormality has occurred in the steering angle sensor 5, the fail-safe processing portion 97 outputs an instruction to the characteristic information correction portion 98 and the limiter setting portion 99, thereby performing processing for gradually reducing the assist torque. The processing for gradually reducing the assist torque will be described in detail below. Further, when the abnormality has occurred in the steering torque sensor 4 or the motor rotational angle sensor 6, the fail-safe processing portion 97 outputs an instruction to the characteristic information correction portion 98 and the limiter setting portion 99, thereby performing Limp Home processing. The Limp Home processing will be described in detail below. Further, when the abnormality has occurred in a plurality of sensors, the fail-safe processing portion 97 outputs an instruction to the fail-safe circuit 75, thereby performing processing for shutting down the system. The processing for shutting down the system is processing that immediately stops the power supply from the inverter circuit 76 to the electric motor 40.

Further, when the battery voltage reduces, the fail-safe processing portion 97 outputs an instruction to the supply power limitation portion 100, thereby performing low voltage processing. The low voltage processing sets the upper limit value on the motor instruction current according to the battery voltage. The supply power limitation portion 100 outputs the set upper limit value to a select LOW processing portion 101. The select LOW processing portion 101 receives inputs of the motor instruction current of the limiter 90e and the upper limit value of the supply power limitation portion 100, and outputs a smaller one of them as a final motor instruction current.

When the abnormality has occurred in the steering torque sensor 4, the steering angle sensor 5, or the motor rotational angle sensor 6, or when the battery voltage reduces, the fail-safe processing portion 97 lights up a warning lamp 102 provided on an instrument panel or the like in a vehicle compartment.

[Processing at the time of Sensor Abnormality]

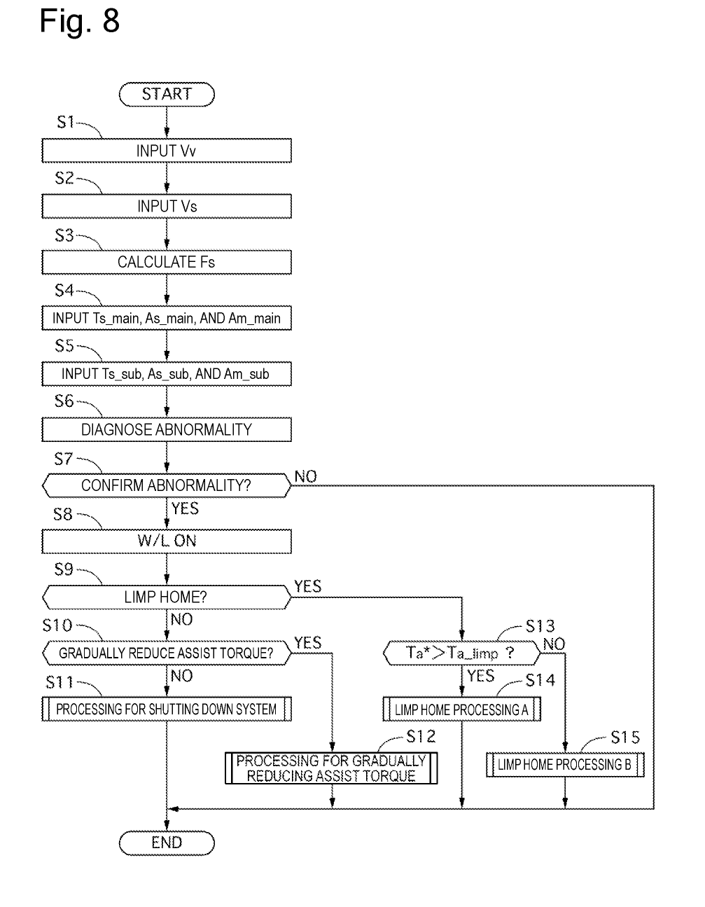

FIG. 8 is a flowchart illustrating a flow of processing performed by the electronic control unit 7 at the time of the sensor abnormality. The following processing is repeated each time a predetermined time period has elapsed while the ignition switch is kept on.

In step S1, the electronic control unit 7 receives an input of a vehicle speed Vv. Then, the processing proceeds to step S2.

In step S2, the electronic control unit 7 receives an input of a steering speed Vs. Then, the processing proceeds to step S3. In the first embodiment, the steering speed Vs is acquired from the steering angle signal.

In step S3, the electronic control unit 7 calculates a steering frequency Fs. Then, the processing proceeds to step S4.

In step S4, the electronic control unit 7 receives inputs of a steering torque signal Ts_main from the main steering torque sensor 4a, a steering angle signal As_main from the main steering angle sensor 5a, and a motor rotational angle signal Am_main from the main motor rotational angle sensor 6a. Then, the processing proceeds to step S5.

In step S5, the electronic control unit 7 receives inputs of a steering torque signal Ts_sub from the sub steering torque sensor 4b, a steering angle signal As_sub from the sub steering angle sensor 5b, and a motor rotational angle signal Am_sub from the sub motor rotational angle sensor 6b. Then, the processing proceeds to step S6.

In step S6, the electronic control unit 7 makes a diagnosis of the abnormality in each of the sensors. Then, the processing proceeds to step S7.

In step S7, the electronic control unit 7 determines whether the abnormality in any of the sensors is confirmed. If the abnormality is confirmed, the processing proceeds to step S8. If the abnormality is not confirmed, the processing is ended. In the confirmation of the abnormality in each of the sensors, the electronic control unit 7 determines to confirm the abnormality when the occurrence of the abnormality (detection of the abnormality) in the sensor continues for a predetermined time period.

In step S8, the electronic control unit 7 lights up the warning lamp 102. Then, the processing proceeds to step S9.

In step S9, the electronic control unit 7 determines whether to perform the Limp Home processing. If the electronic control unit 7 performs the Limp Home processing, the processing proceeds to step S13. If the electronic control unit 7 does not perform the Limp Home processing, the processing proceeds to step S10.

In step S10, the electronic control unit 7 determines whether to perform the processing for gradually reducing the assist torque. If the electronic control unit 7 performs the processing for gradually reducing the assist torque, the processing proceeds to step S12. If the electronic control unit 7 does not perform the processing for gradually reducing the assist torque, the processing proceeds to step S11.

In step S11, the electronic control unit 7 shuts down the system of the power steering apparatus 1, and the vehicle transitions to manual steering. The manual steering refers to a lack of the provision of the assist torque by the power steering apparatus 1.

In step S12, the electronic control unit 7 performs the processing for gradually reducing the assist torque. Then, the processing is ended.

In step S13, the electronic control unit 7 determines whether a target assist torque Ta* is larger than an assist torque upper limit value Ta_limp used at the time of Limp Home. If the target assist torque Ta* is larger than the assist torque upper limit value Ta_limp, the processing proceeds to step S14. If the target assist torque Ta* is equal to or smaller than the assist torque upper limit value Ta_limp, the processing proceeds to step S15. The value of the assist torque upper limit value Ta_limp may be set arbitrarily. However, the assist torque upper limit value Ta_limp is set to a smaller value than the assist torque upper limit value Ta_limit used at the time of normal control (when the sensor operates normally).

In step S14, the electronic control unit 7 performs the Limp Home processing A. Then, the processing is ended.

In step S15, the electronic control unit 7 performs the Limp Home processing B. Then, the processing is ended.

(Processing for Gradually Reducing Assist Torque)

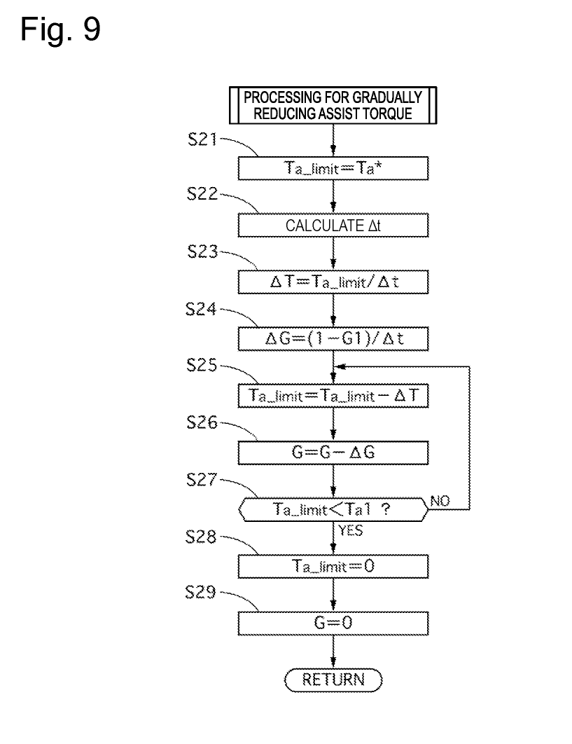

FIG. 9 is a flowchart illustrating a flow of the processing for gradually reducing the assist torque that is performed in step S12 illustrated in FIG. 8.

In step S21, the electronic control unit 7 sets the assist torque upper limit value Ta_limit to the target assist torque Ta*. Then, the processing proceeds to step S22. The limiter setting portion 99 sets the upper limit value in the limiter 90e to a control current applied when the electric motor 40 is controlled in such a manner that the assist torque reaches the assist torque upper limit value Ta_limit.

In step S22, the electronic control unit 7 calculates a gradual reduction time period Δt. Then, the processing proceeds to step S23. The gradual reduction time period Δt is calculated so as to increase as the vehicle speed, the steering frequency, and the steering torque increases.

In step S23, the electronic control unit 7 sets an upper limit value reduction speed AT according to the following equation. Then, the processing proceeds to step S24.

ΔT=Ta_limit/Δt

In step 824, the electronic control unit 7 sets a gain reduction speed AG according to the following equation. Then, the processing proceeds to step S25.

ΔG=(1−G1)/Δt

In this equation, G1 represents a predetermined value equal to or smaller than 1.

In step S25, the electronic control unit 7 sets the assist torque upper limit value Ta_limit according to the following equation. Then, the processing proceeds to step S26.

Ta_limit=Ta_limit−ΔT

In step S26, the electronic control unit 7 sets the gain G according to the following equation. Then, the processing proceeds to step S27.

G=G−ΔG

The Gain G is set to 1 as an initial value thereof before the processing for gradually reducing the assist torque is performed.

In step S27, the electronic control unit 7 determines whether the assist torque upper limit value Ta_limit is smaller than Ta1. If the assist torque upper limit value Ta_limit is smaller than Ta1, the processing proceeds to step S28. If the assist torque upper limit value Ta_limit is equal to or larger than Ta1, the processing returns to step S25. Ta1 represents a predetermined value to determine that the assist torque upper limit value Ta_limit reduces to a sufficiently small value.

In step S28, the electronic control unit 7 sets the assist torque upper limit value Ta_limit to zero. Then, the processing proceeds to step S29.

In step S29, the electronic control unit 7 sets the gain G to zero. Then, the processing is ended.

(Limp Home Processing A)

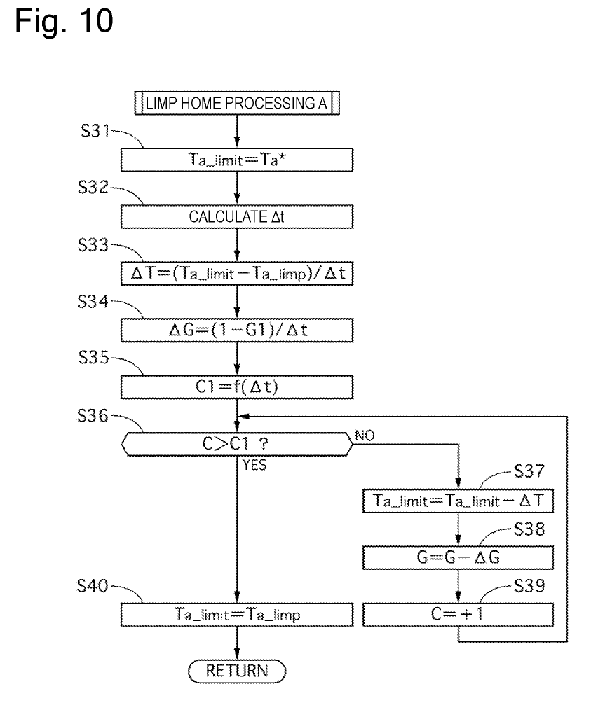

FIG. 10 is a flowchart illustrating a flow of the Limp Home processing A that is performed in step S14 illustrated in FIG. 8.

In step S31, the electronic control unit 7 sets the assist torque upper limit value Ta_limit to the target assist torque Ta*. Then, the processing proceeds to step S32. The limiter setting portion 99 sets the upper limit value in the limiter 90e to the control current applied when the electric motor 40 is controlled in such a manner that the assist torque reaches the assist torque upper limit value Ta_limit.

In step S32, the electronic control unit 7 calculates the gradual reduction time period Δt. Then, the processing proceeds to step S33. The gradual reduction time period Δt is calculated so as to increase as the vehicle speed, the steering frequency, and the steering torque increases.

In step S33, the electronic control unit 7 sets the upper limit value reduction speed ΔT according to the following equation. Then, the processing proceeds to step S24.

ΔT=(Ta_limit−Ta_limp)/Δt

In step S34, the electronic control unit 7 sets the gain reduction speed ΔG according to the following equation. Then, the processing proceeds to step S35.

ΔG=(1−G1)/Δt

In this equation, G1 represents the predetermined value equal to or smaller than 1.

In step 835, the electronic control unit 7 sets a counter threshold value C1 according to the gradual reduction time period Δt. Then, the processing proceeds to step S36. The counter threshold value C1 is set to the number of times that processing of step 836 to step S39, which will be described below, can be performed within the gradual reduction time period Δt.

In step 836, the electronic control unit 7 determines whether a counter C is larger than the counter threshold value C1. If the counter C is larger than the counter threshold value C1, the processing proceeds to step S40. If the counter C is equal to or smaller than the counter threshold value C1, the processing proceeds to step 837.

In step S37, the electronic control unit 7 sets the assist torque upper limit value Ta_limit according to the following equation. Then, the processing proceeds to step 828.

Ta_limit=Ta_limit−ΔT

In step S38, the electronic control unit 7 sets the gain G according to the following equation. Then, the processing proceeds to step 839.

G=G−ΔG

The Gain G is set to 1 as an initial value thereof before the Limp Home A processing is performed.

In step 839, the electronic control unit 7 increments the counter C. Then, the processing returns to step 836.

In step S40, the electronic control unit 7 sets the assist torque upper limit value Ta_limit to the assist torque upper limit value Ta_limp used at the time of the Limp Home. Then, the processing is ended.

(Limp Home Processing B)

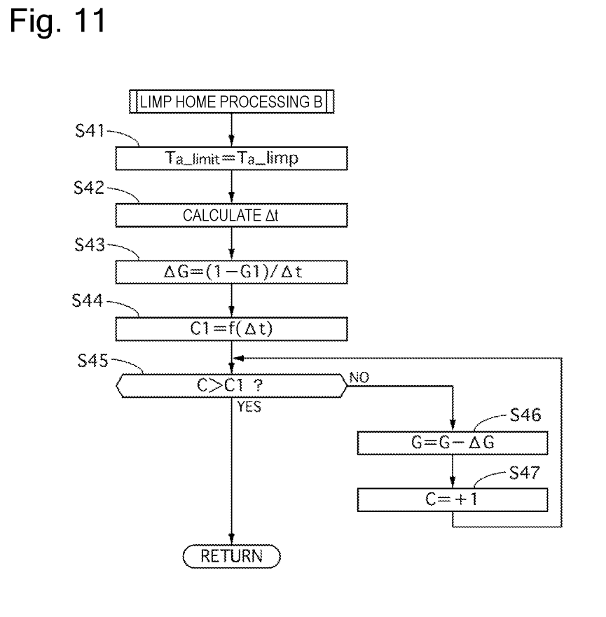

FIG. 11 is a flowchart illustrating a flow of the Limp Home processing B that is performed in step S15 illustrated in FIG. 8.

In step S41, the electronic control unit 7 sets the assist torque upper limit value Ta_limit to the assist torque upper limit value Ta_limp used at the time of the Limp Home. Then, the processing proceeds to step S42. The limiter setting portion 99 sets the upper limit value in the limiter 90e to the control current applied when the electric motor 40 is controlled in such a manner that the assist torque reaches the assist torque upper limit value Ta_limit.

In step S42, the electronic control unit 7 calculates the gradual reduction time period Δt. Then, the processing proceeds to step S43. The gradual reduction time period Δt is calculated so as to increase as the vehicle speed, the steering frequency, and the steering torque increases.

In step S43, the electronic control unit 7 sets the gain reduction speed ΔG according to the following equation. Then, the processing proceeds to step S44.

ΔG=(1−G1)/Δt

In this equation, G1 represents the predetermined value equal to or smaller than 1.

In step S44, the electronic control unit 7 sets the counter threshold value C1 according to the gradual reduction time period Δt. Then, the processing proceeds to step S35. The counter threshold value C1 is set to the number of times that processing of step S45 to step S47, which will be described below, can be performed within the gradual reduction time period Δt.

In step S45, the electronic control unit 7 determines whether the counter C is larger than the counter threshold value C1. If the counter C is larger than the counter threshold value C1, the processing is ended. If the counter C is equal to or smaller than the counter threshold value C1, the processing proceeds to step S46.

In step S46, the electronic control unit 7 sets the gain G according to the following equation. Then, the processing proceeds to step S39.

G=G−ΔG

The Gain G is set to 1 as an initial value thereof before the Limp Home B processing is performed.

In step S47, the electronic control unit 7 increments the counter C. Then, the processing returns to step S45.

[Regarding Processing for Gradually Reducing Assist Torque]

The processing for gradually reducing the assist torque is control of gradually reducing the assist torque to eventually set the assist torque to zero. The processing for gradually reducing the assist torque is performed, for example, when the abnormality has occurred in the steering angle sensor 5. The electronic control unit 7 according to the first embodiment does not have a function of calculating the alternative steering angle signal when the abnormality has occurred in the steering angle sensor 5. Therefore, when the abnormality has occurred in the steering angle sensor 5, the power steering apparatus 1 may be unable to provide an appropriate assist torque, and therefore is configured to eventually set the assist torque to zero.

However, suddenly reducing the assist torque may exercise an influence on the steering by the driver. Further, the steering angle signal is used only to calculate the assist torque when the steering wheel is steered in the return direction. For these reasons, the power steering apparatus 1 is configured to eliminate or reduce the influence on the steering by the driver by gradually reducing the assist torque although the steering feeling is deteriorated when the steering wheel is steered in the return direction.

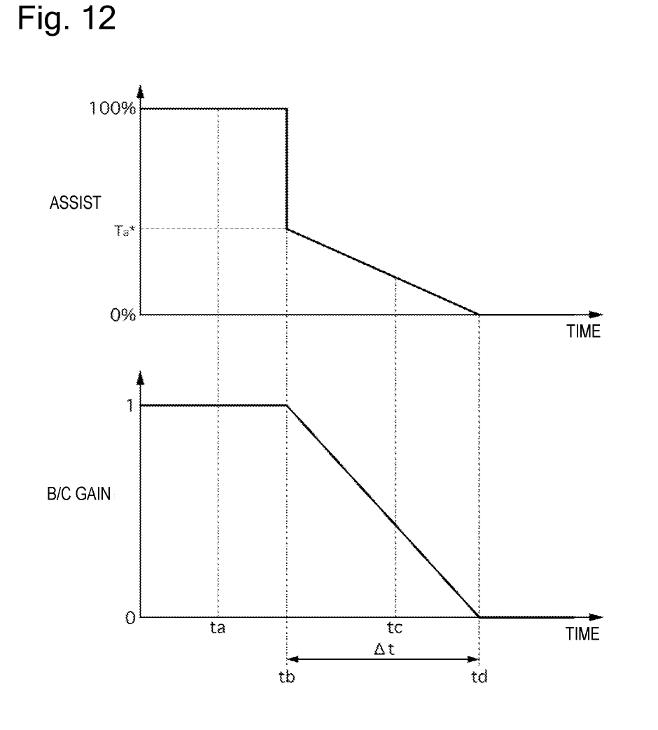

FIG. 12 illustrates timing charts of the assist torque upper limit value Ta_limit and the gain G during the processing for gradually reducing the assist torque. An upper timing chart indicates the assist torque upper limit value Ta_limit, and a lower timing chart indicates the gain G. The assist torque upper limit value Ta_limit indicates the assist torque when the electric motor 40 is controlled according to the upper limit value on the motor instruction current in the limiter 90e that is set by the limiter setting portion 99. The gain G is a numerical value of the gain G in the gain 90b that is set by the characteristic information correction portion 98.

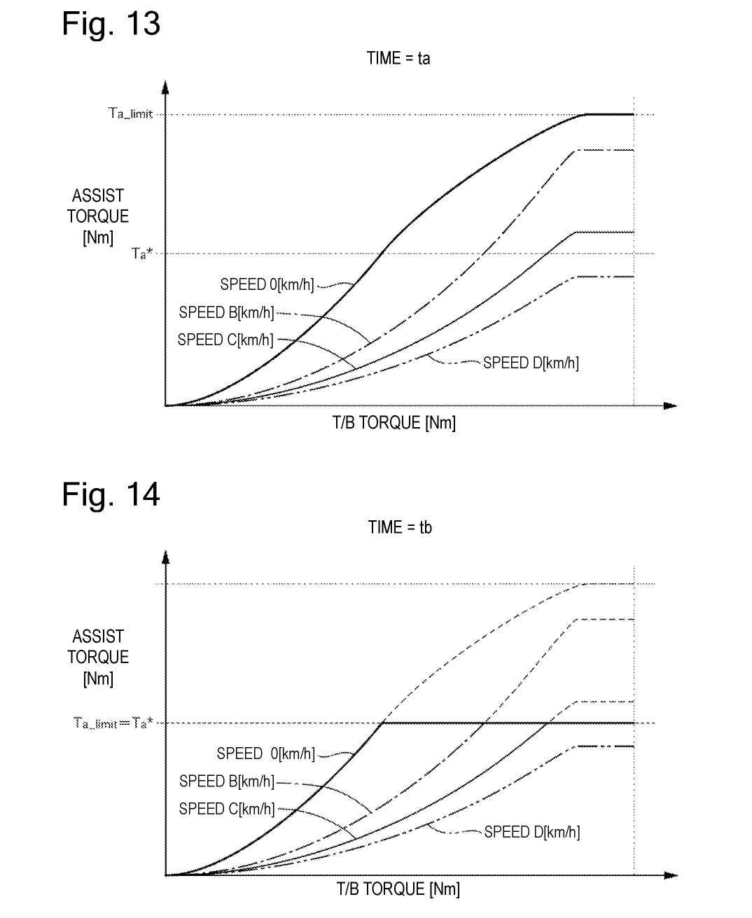

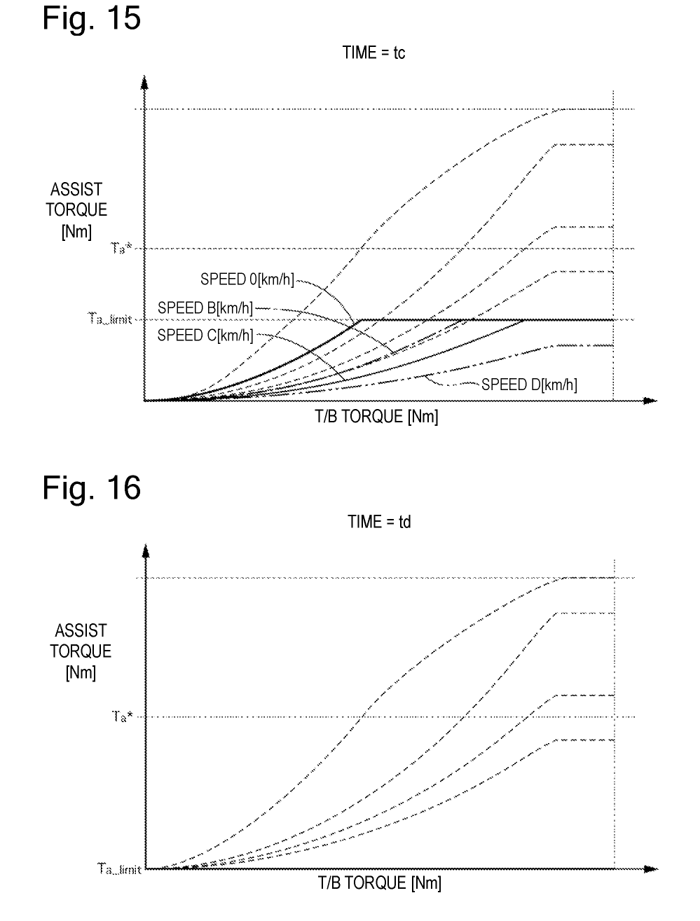

FIG. 13 is a graph indicating a relationship between the steering torque (a torsion bar torque) and the target assist torque at time ta. As described above, the target assist torque and the motor instruction current are highly correlated with each other and are approximately proportional to each other, so that this graph may be handled as a target assist torque map substantially equivalent to the motor instruction current map 90a. Further, the steering torque matches a steering reaction force on the steering wheel. FIG. 14 illustrates the target assist torque map at time tb. FIG. 15 illustrates the target assist torque map at time tc. FIG. 16 illustrates the target assist torque map at time td.

(Time ta: When Sensor Abnormality is Not Confirmed)

At time ta, the power steering apparatus 1 is in such a state that the abnormality in the steering angle sensor 5 is not confirmed yet. At this time, the assist torque upper limit value Ta_limit is set to a maximum value within an allowable output range of the electric motor 40. The gain G is set to 1.

(Time tb: When Sensor Abnormality is Confirmed)

At time tb, the abnormality in the steering angle sensor 5 is confirmed. At this time, the assist torque upper limit value Ta _limit is set to the present target assist torque ta*. The gain G is set to 1 as of time tb.

The assist torque upper limit value Ta_limit reduces to the present target assist torque Ta* at once, but this reduction has no influence on the steering by the driver because the outputted assist torque itself is not changed.

(Time tc: When Assist Torque Gradually Reduces)

After time tb at which the abnormality in the steering angle sensor 5 is confirmed, the electronic control unit 7 gradually reduces the assist torque upper limit value Ta_limit. The electronic control unit 7 linearly gradually reduces the assist torque upper limit value Ta_limit. In other words, the electronic control unit 7 reduces the assist torque upper limit value Ta _limit while keeping a reduction speed thereof constant. After time tb, the electronic control unit 7 gradually reduces the gain G. The electronic control unit 7 linearly gradually reduces the gain G. In other words, the electronic control unit 7 reduces the gain G while keeping a reduction speed thereof constant.

Due to the gradual reduction in the assist torque upper limit value Ta_limit, the assist torque gradually reduces even if the driver keeps a steering state (the steering torque and the vehicle speed) at time tb constant. Therefore, the driver feels as if a steering load gradually increases. Due to this feeling, the driver can recognize that some abnormality has occurred in the power steering apparatus 1. Further, due to the gradual reduction in the assist torque, the present configuration can eliminate or reduce the influence on the steering by the driver due to the reduction in the assist torque.

Further, reducing the gain G leads to a reduction in a gradient of the target assist torque with respect to the steering torque in the target assist torque map (FIG. 15). Therefore, when the driver returns the steering wheel to a neutral state and additionally steers the steering wheel again, the driver feels as if the steering load increases compared to during the previous steering. Due to this feeling, the driver can recognize that some abnormality has occurred in the power steering apparatus 1. Further, due to the gradual reduction in the gain G, the present configuration can eliminate or reduce the influence on the steering by the driver due to the reduction in the assist torque.

(Time td: Completion of Gradual Reduction in Assist Torque)

At time td after the gradual reduction time period Δt has elapsed from time tb, the assist torque upper limit value Ta _limit and the gain G are set to zero. In other words, the assist torque reduces to zero, and the manual steering starts.

[Regarding Limp Home Processing A]

The Limp Home processing A is control of allowing the output of the assist torque to some degree although reducing the assist torque. The Limp Home processing A is performed, for example, when the abnormality has occurred in the steering torque sensor 4 or the motor rotational angle sensor 6. The electronic control unit 7 according to the first embodiment calculates the alternative steering torque signal or the alternative motor rotational angle signal when the abnormality has occurred in the steering torque sensor 4 or the motor rotational angle sensor 6. When performing the control of providing the assist torque with use of the alternative signal, the electronic control unit 7 at least can appropriately provide the assist torque, although the steering feeling of the driver is slightly deteriorated compared to performing the control of providing the assist torque with use of the sensor signal.

However, if continuing providing the assist torque while keeping operating in this manner, the driver may not recognize that the abnormality has occurred in the power steering apparatus 1. Therefore, the electronic control unit 7 operates so as to continue the control while limiting the strength of the assist torque to be provided.

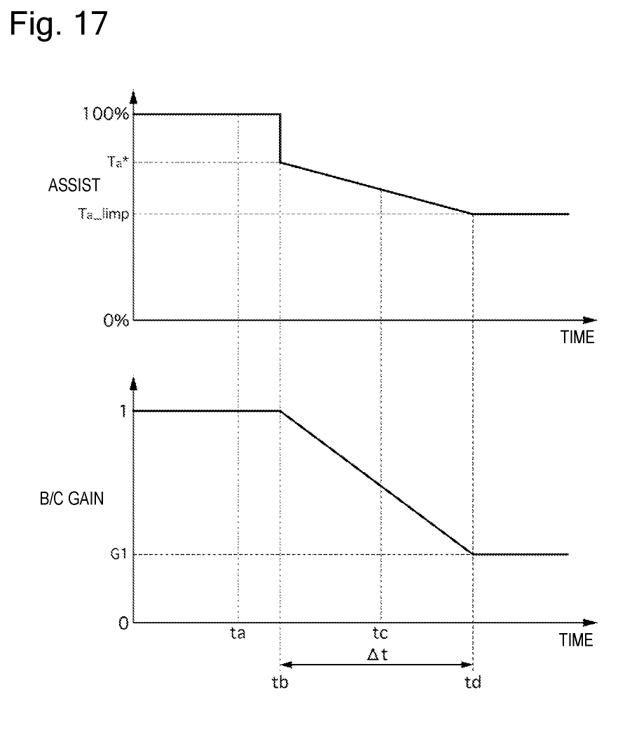

FIG. 17 illustrates timing charts of the assist torque upper limit value Ta_limit and the gain G during the Limp Home processing A. An upper timing chart indicates the assist torque upper limit value Ta_limit, and a lower timing chart indicates the gain G.

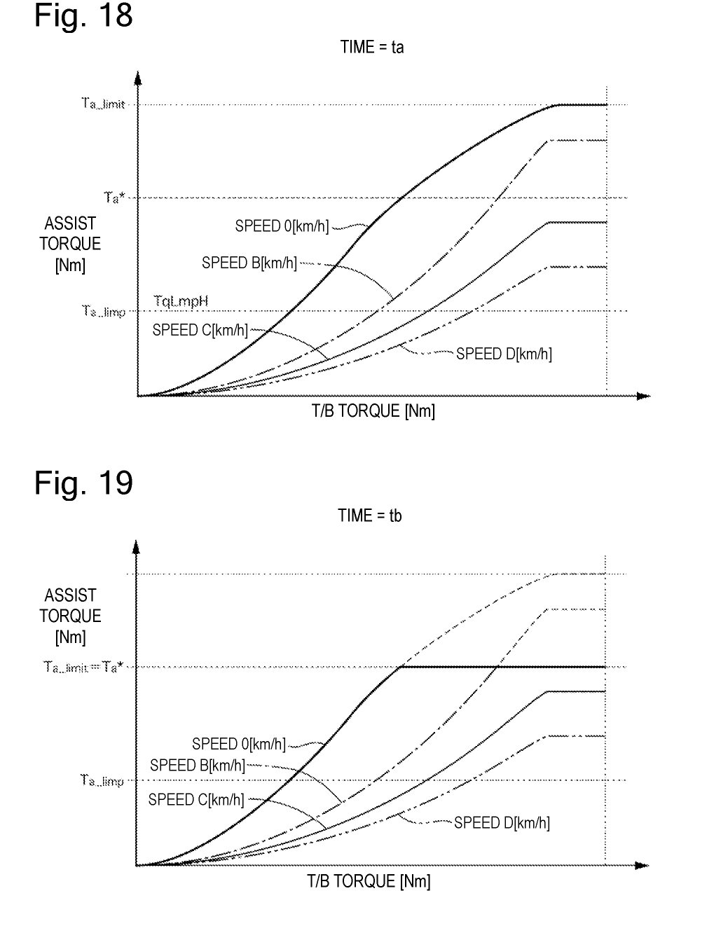

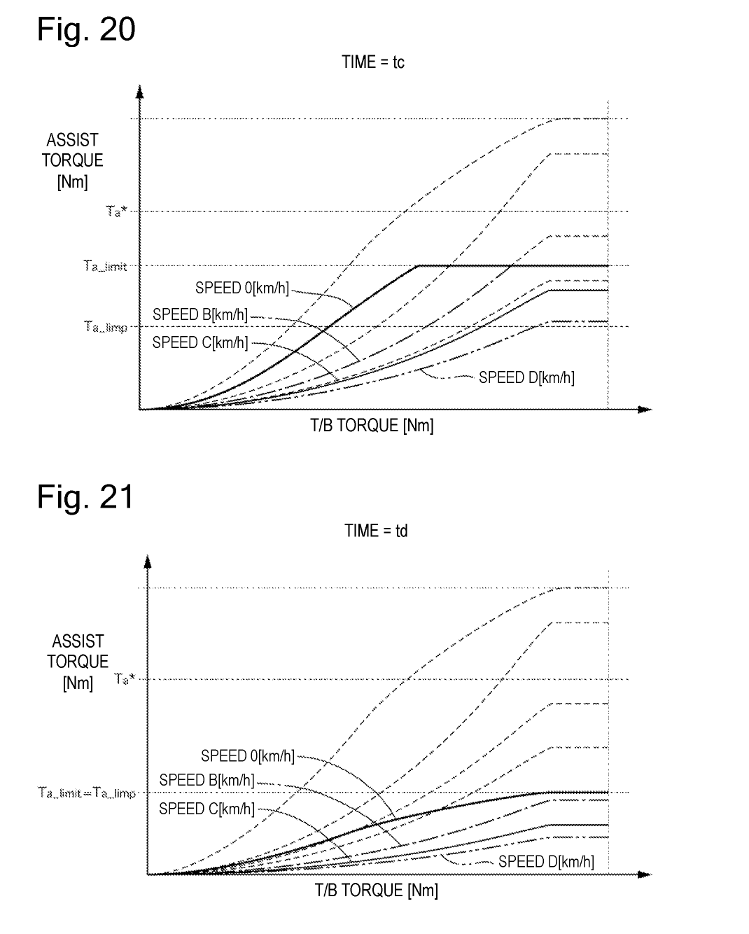

FIG. 18 illustrates the target assist torque map at time ta. FIG. 19 illustrates the target assist torque map at time tb. FIG. 20 illustrates the target assist torque map at time tc. FIG. 21 illustrates the target assist torque map at time td.

(Time ta: When Sensor Abnormality is Not Confirmed)

At time ta, the power steering apparatus 1 is in such a state that the abnormality in the steering angle sensor 5 is not confirmed yet. At this time, the assist torque upper limit value Ta_limit is set to the maximum value within the allowable output range of the electric motor 40. The gain G is set to 1.

(Time tb: When Sensor Abnormality is Confirmed)

At time tb, the abnormality in the steering angle sensor 5 is confirmed. At this time, the assist torque upper limit value Ta_limit is set to the present target assist torque ta*. The gain G is set to 1 as of time tb.

The assist torque upper limit value Ta_limit reduces to the present target assist torque Ta* at once, but this reduction has no influence on the steering by the driver because the outputted assist torque itself is not changed.

(Time tc: When Assist Torque Gradually Reduces)

After time tb at which the abnormality in the steering angle sensor 5 is confirmed, the electronic control unit 7 gradually reduces the assist torque upper limit value Ta_limit. The electronic control unit 7 linearly gradually reduces the assist torque upper limit value Ta_limit. After time tb, the electronic control unit 7 gradually reduces the gain G.

Due to the gradual reduction in the assist torque upper limit value Ta_limit, the assist torque gradually reduces even if the driver keeps the steering state (the steering torque and the vehicle speed) at time tb constant. Therefore, the driver feels as if the steering load gradually increases. Due to this feeling, the driver can recognize that some abnormality has occurred in the power steering apparatus 1. Further, due to the gradual reduction in the assist torque, the present configuration can eliminate or reduce the influence on the steering by the driver due to the reduction in the assist torque.

Further, reducing the gain G leads to the reduction in the gradient of the target assist torque with respect to the steering torque in the target assist torque map (FIG. 20). Therefore, when the driver returns the steering wheel to the neutral state and additionally steers the steering wheel again, the driver feels as if the steering load increases compared to during the previous steering. Due to this feeling, the driver can recognize that some abnormality has occurred in the power steering apparatus 1. Further, due to the gradual reduction in the gain G, the present configuration can eliminate or reduce the influence on the steering by the driver due to the reduction in the assist torque.

(Time td: Completion of Gradual Reduction in Assist Torque)

At time td after the gradual reduction time period Δt has elapsed from time tb, the assist torque upper limit value Ta_limit is set to the assist torque upper limit value Ta_limp used at the time of the Limp Home. The gain G is set to G1.

Due to these settings, the power steering apparatus 1 is brought into a state where the maximum value of the assist torque is limited in the control at and after time td. Further, the rise of the assist torque also slows down.

[Regarding Limp Home Processing B]

The Limp Home processing B is control of allowing the output of the assist torque to some degree although reducing the assist torque, similarly to the Limp Home processing A. The Limp Home processing B is performed, for example, when the abnormality has occurred in the steering torque sensor 4 or the motor rotational angle sensor 6.

In the Limp Home processing A, the electronic control unit 7 operates so as to set the assist torque upper limit value Ta _limit to the target assist torque Ta*, and thereafter gradually reduces the assist torque upper limit value Ta_limit to the assist torque upper limit value Ta_limp. This is processing for eliminating or reducing the influence on the steering by the driver because the Limp Home processing A is performed in the case where the target assist torque Ta* when the sensor abnormality is confirmed is larger than the assist torque upper limit value Ta_limp.

On the other hand, the Limp Home processing B is performed in the case where the target assist torque Ta* when the sensor abnormality is confirmed is smaller than the assist torque upper limit value Ta_limp. Therefore, the electronic control unit 7 operates so as to reduce the assist torque upper limit value Ta_limit to the assist torque upper limit value Ta_limp at once when the sensor abnormality is confirmed.

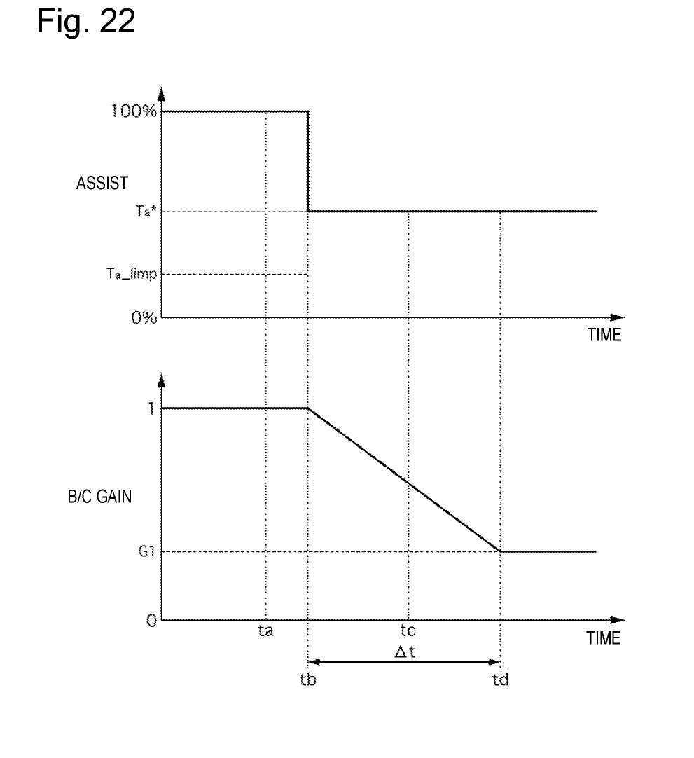

FIG. 22 illustrates timing charts of the assist torque upper limit value Ta_limit and the gain G during the Limp Home processing B. An upper timing chart indicates the assist torque upper limit value Ta_limit, and a lower timing chart indicates the gain G.

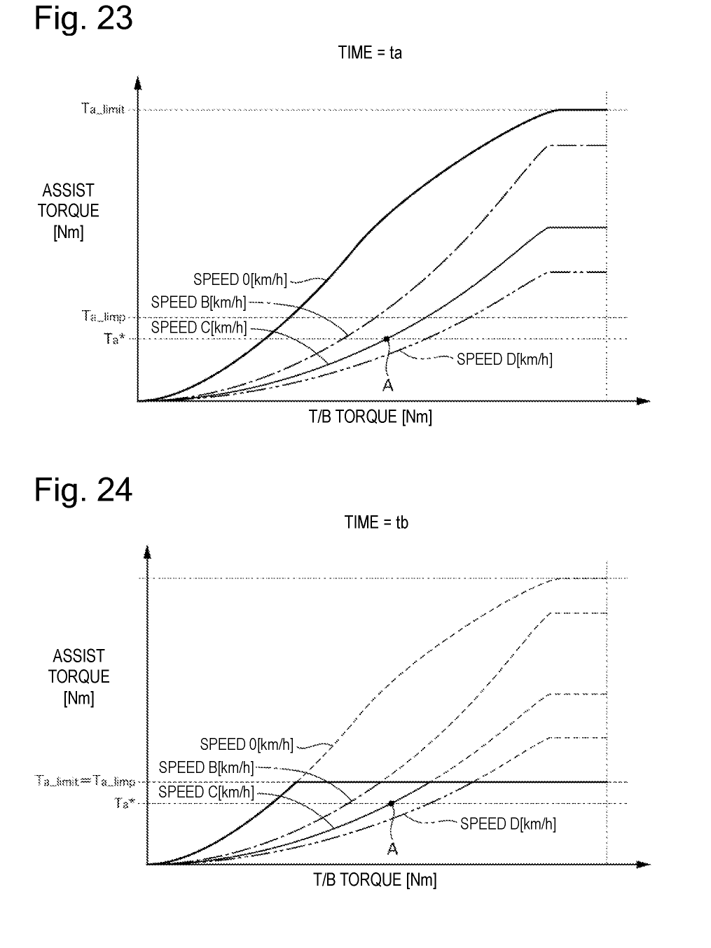

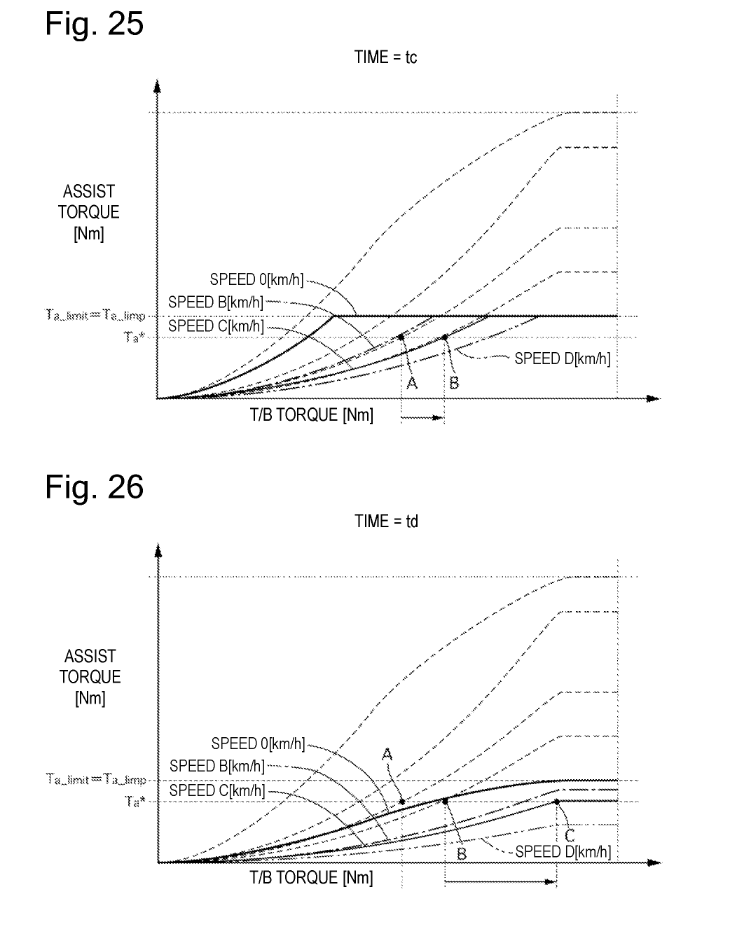

FIG. 23 illustrates the target assist torque map at time ta. FIG. 24 illustrates the target assist torque map at time tb. FIG. 25 illustrates the target assist torque map at time tc. FIG. 26 illustrates the target assist torque map at time td.

(Time ta: When Sensor Abnormality is Not Confirmed)

At time ta, the power steering apparatus 1 is in such a state that the abnormality in the steering angle sensor 5 is not confirmed yet. At this time, the assist torque upper limit value Ta_limit is set to the maximum value within the allowable output range of the electric motor 40. The gain G is set to 1.

(Time tb: When Sensor Abnormality is Confirmed)

At time tb, the abnormality in the steering angle sensor 5 is confirmed. At this time, the assist torque upper limit value Ta_limit is set to the assist torque upper limit value Ta_limp. The gain G is set to 1 as of time tb.

The assist torque upper limit value Ta_limit reduces to the assist torque upper limit value Ta_limp at once, but this reduction has no influence on the steering by the driver because the target assist torque Ta* is smaller than the assist torque upper limit value Ta_limp.

(Time tc: When Assist Torque Gradually Reduces)

After time tb at which the abnormality in the steering angle sensor 5 is confirmed, the electronic control unit 7 keeps the assist torque upper limit value Ta_limit at the assist torque upper limit value Ta_limp. After time tb, the electronic control unit 7 gradually reduces the gain G.

Reducing the gain G leads to the reduction in the gradient of the target assist torque with respect to the steering torque in the target assist torque map (FIG. 25). Therefore, when the driver returns the steering wheel to the neutral state and additionally steers the steering wheel again, the driver feels as if the steering load increases compared to during the previous steering. Due to this feeling, the driver can recognize that some abnormality has occurred in the power steering apparatus 1. Further, due to the gradual reduction in the gain G, the present configuration can eliminate or reduce the influence on the steering by the driver due to the reduction in the assist torque.

(Time td: Completion of Gradual Reduction in Assist Torque)

At time td after the gradual reduction time period Δt has elapsed from time tb, the gain G is set to G1. Due to this setting, the rise of the assist torque also slows down in the control at and after time td.

[Effects of Reduction in Gain]

In the description of each of the above-described control types, they have been described referring to such an effect that the reduction in the gain G makes the driver feel as if the steering load gradually increases compared to during the previous steering when additionally steering the steering wheel after locating it to the neutral position. Other effects from the reduction in the gain G include an increase in a ratio of the steering torque to the assist torque. This effect will be described with reference to FIGS. 23 to 26.

For simplification of the description, suppose that the target assist torque Ta* is controlled so as to be kept constant from time ta to time td. At time ta and time tb (FIGS. 23 and 24) before the gain G reduces, a control point is placed at a point A in the target assist torque map. The gain G starts reducing, and the control point shifts to a point B at time tc (FIG. 25). The gain G further reduces, and the control point shifts to a point C at time td (FIG. 26). It can be understood that, as the control point shifts from the point A to the point B to the point C, the steering torque increases and the ratio of the steering torque to the assist torque increases. In other words, even when the steering of the steering wheel is maintained, reducing the gain G makes the driver feel as if the steering load increases.

As illustrated in FIG. 23, the target assist torque Ta* is small when the steering load is light (when the steering torque is small). Gradually reducing the assist torque upper limit value Ta_limit means first limiting the target assist torque Ta* in a high steering load region and then also limiting the target assist torque Ta* in a low steering load region as time passes. In other words, in the low steering load region, the driver cannot feel the increase in the steering load or takes a long time to start feeling the increase in the steering load. Therefore, the driver may be unable to recognize that the abnormality has occurred in the power steering apparatus 1 or may take a long time to recognize it.

As time passes from the start of the gradual reduction in the assist torque upper limit value Ta_limit, the assist torque upper limit value Ta_limit further reduces to a smaller value and eventually reaches zero. In other words, when the steering by the driver is located in the low steering load region, the driver may feel that the assist torque suddenly reduces and the steering load suddenly increases.

In the first embodiment, the power steering apparatus 1 can reduce the target assist torque Ta* regardless of a steering condition of the driver (regardless of the present steering load) by gradually reducing the gain G. Therefore, the power steering apparatus 1 allows the driver to recognize the increase in the steering load since immediately after the abnormality has occurred in the power steering apparatus 1.

[Effects of Reduction in Assist Torque Upper Limit Value]

As illustrated in FIG. 23, the gradient of the assist torque with respect to the steering torque is steep in the high steering load region as a whole, compared to in the low steering load region. The reduction in the gain G can lead to a reduction in the gradient of the assist torque with respect to the steering torque, but the steering load increases due to the reduction in the gain G by a smaller amount in the high steering load region compared in the low steering load region. In other words, the increase in the steering load becomes less recognizable for the driver in the high steering load region, and therefore the driver may be unable to recognize that the abnormality has occurred in the power steering apparatus 1.

In the first embodiment, the power steering apparatus 1 is configured to also reduce the assist torque upper limit value Ta_limit along with reducing the gain G. By this configuration, the driver can also recognize the increase in the steering load even in the high steering load region.

[Advantageous Effects]

(1) The electronic control unit 7 (a control apparatus) is used in the power steering apparatus 1 configured to provide the steering force (the assist torque) to the steering mechanism 2 with use of the electric motor 40. The steering mechanism 2 is configured to turn the turning target wheel according to the steering operation performed on the steering wheel. The electronic control unit 7 includes the main steering torque signal reception portion 7b (a torque signal reception portion) configured to receive the signal of the steering torque generated on the steering mechanism 2, the motor instruction current calculation portion 90 (an instruction signal calculation portion) configured to calculate the instruction signal (the motor instruction current) for driving and controlling the electric motor 40 based on the signal of the steering torque, and having the characteristic information that increases the instruction signal as the steering torque increases, the fail-safe processing portion 97 (an assist limitation instruction signal reception portion) configured to receive the assist limitation instruction signal for reducing the power to be supplied to the electric motor 40, the characteristic information correction portion 98 configured to correct the characteristic information in such a manner that the instruction signal according to the steering torque gradually reduces according to the reception of the assist limitation instruction signal by the fail-safe processing portion 97, and the motor control circuit 7g and the inverter circuit 76 (a drive power supply portion) configured to supply the drive power for driving the electric motor to the electric motor based on the instruction signal.

Therefore, due to the gradual reduction in the instruction signal (the motor instruction current), the assist torque gradually reduces and therefore the driver can feel as if the steering reaction force gradually increases regardless of the steering condition. As a result, the electronic control unit 7 allows the driver to recognize the assist limitation even immediately after the fail-safe processing portion 97 receives the assist limitation instruction signal. Therefore, the electronic control unit 7 can eliminate or reduce the discomfort that the driver otherwise would feel at the time of the assist limitation.

(2) The electronic control unit 7 includes the limiter setting portion 99 (an upper limit value setting portion) configured to set the upper limit value on the instruction signal. The limiter setting portion 99 gradually reduces the upper limit value on the instruction signal according to the reception of the assist limitation instruction signal by the fail-safe processing portion 97.

Therefore, due to the gradual reduction in the upper limit value on the instruction signal, the driver can feel the increase in the steering load even in the high steering load region. Therefore, the electronic control unit 7 allows the driver to recognize the assist limitation even in the high steering load region.

(3) The characteristic information correction portion 98 corrects the map by changing the gain for multiplying the map in the motor instruction current map 90a (the characteristic information) thereby.

Therefore, the electronic control unit 7 can correct the map while preventing or cutting down the increase in the data amount of the map in the motor instruction current map 90a.

(4) The characteristic information correction portion 98 corrects the motor current instruction value by multiplying the motor current instruction value (the instruction signal) calculated according to the map in the motor instruction current map 90a (the characteristic information) by the gain.

Because multiplying the motor current instruction value output from the motor instruction current map 90a by the gain, the electronic control unit 7 can prevent or cut down the increase in the calculation load compared to when correcting the entire map in the motor instruction current map 90a.

(5) The electronic control unit 7 includes the limiter setting portion 99 (an upper limit value setting portion) configured to set the upper limit value on the instruction signal. The limiter setting portion 99 sets the upper limit value to the same value as the instruction signal when the fail-safe processing portion 97 receives the assist limitation instruction signal.

Therefore, since immediately after the assist limitation starts, the steering load increases, and the driver can recognize the assist limitation.

(6) The electronic control unit 7 is configured to output the signal for lighting up the warning lamp 102 mounted on the vehicle according to the reception of the assist limitation signal by the fail-safe processing portion 97.

Therefore, the electronic control unit 7 can directly notify the driver of the assist limitation by means of the lighting-up of the warning lamp 102 in addition to the indirect notification of the assist limitation due to the increase in the steering load.

(7) The electronic control unit 7 includes the supply power limitation portion 100 configured to set the upper limit value on the power to be supplied to the electric motor 40 according to the reception of the assist limitation signal by the fail-safe processing portion 97. The inverter circuit 76 supplies the drive power for driving the electric motor to the electric motor 40 based on the smaller one of the upper limit value set by the supply power limitation portion 100 and the instruction signal corrected by the characteristic information correction portion 98.

The electronic control unit 7 can improve safety of the assist control of the power steering apparatus 1 by, when the assist limitation is exerted by the supply power limitation portion 100 besides the assist limitation by the characteristic information correction portion 98, selecting the smaller one of the instruction signals corrected according to the upper limit values of both of them.

(8) The characteristic information correction portion 98 linearly gradually reduces the characteristic information.

Therefore, the electronic control unit 7 can smoothly increase the steering load, thereby eliminating or reducing the uncomfortable steering feeling due to the increase in the steering load.

(9) The electronic control unit 7 includes the CAN communication circuit 71 configured to receive the signal of the vehicle speed. The characteristic information correction portion 98 increases the time period during which the characteristic information is corrected (the gradual reduction time period Δt) as the vehicle speed increases.

As the vehicle speed increases, the change in the steering reaction force exercises a larger influence on the steering by the driver. Therefore, the electronic control unit 7 can eliminate or reduce the influence on the steering by the driver to thereby improve the safety when the vehicle is running, by increasing the gradual reduction time period Δt as the vehicle speed increases.

(10) The electronic control unit 7 includes the steering frequency signal calculation portion 103 (a steering frequency signal reception portion) configured to receive the signal regarding the frequency of the steering operation. The characteristic information correction portion 98 increases the time period during which the characteristic information is corrected (the gradual reduction time period Δt) as the steering frequency increases.

As the steering frequency increases, the change in the steering reaction force exercises a larger influence on the steering by the driver. Therefore, the electronic control unit 7 can eliminate or reduce the influence on the steering by the driver to thereby improve the safety when the vehicle is running, by increasing the gradual reduction time period Δt as the steering frequency increases.

(11) The characteristic information correction portion 98 increases the time period during which the characteristic information is corrected (the gradual reduction time period Δt) as the steering torque increases.

As the steering torque increases, the change in the steering reaction force exercises a larger influence on the steering by the driver. Therefore, the electronic control unit 7 can eliminate or reduce the influence on the steering by the driver to thereby improve the safety when the vehicle is running, by increasing the gradual reduction time period Δt.

(12) The power steering apparatus 1 includes the steering mechanism 2 configured to turn the turning target wheel according to the steering operation performed on the steering wheel, the electric motor 40 configured to provide the steering force to the steering mechanism 2, the electronic control unit 7 (a controller) configured to drive and control the electric motor, the main steering torque signal reception portion 7b (a torque signal reception portion) provided in the electronic control unit 7 and configured to receive the signal of the steering torque generated on the steering mechanism 2, the motor instruction current calculation portion 90 (an instruction signal calculation portion) provided in the electronic control unit 7, configured to calculate the instruction signal (the motor instruction current) for driving and controlling the electric motor 40 based on the signal of the steering torque, and having the characteristic information that increases the instruction signal as the steering torque increases, the fail-safe processing portion 97 (an assist limitation instruction signal reception portion) provided in the electronic control unit 7 and configured to receive the assist limitation instruction signal for reducing the power to be supplied to the electric motor 40, the characteristic information correction portion 98 provided in the electronic control unit 7 and configured to correct the characteristic information in such a manner that the instruction signal according to the steering torque gradually reduces according to the reception of the assist limitation instruction signal by the fail-safe processing portion 97, and the motor control circuit 7g and the inverter circuit 76 (a drive power supply portion) provided in the electronic control unit 7 and configured to supply the drive power for driving the electric motor to the electric motor based on the instruction signal.

Therefore, due to the gradual reduction in the instruction signal (the motor instruction current), the assist torque gradually reduces and therefore the driver can feel as if the steering reaction force gradually increases regardless of the steering condition. As a result, the power steering apparatus 1 allows the driver to recognize the assist limitation even immediately after the fail-safe processing portion 97 receives the assist limitation instruction signal. Therefore, the power steering apparatus 1 can eliminate or reduce the discomfort that the driver otherwise would feel at the time of the assist limitation.

### Other Embodiments

Having described how the present invention can be embodied based on the first embodiment, the specific configuration of each embodiment of the present invention is not limited to the first embodiment, and the present invention also includes a design modification and the like thereof made within a range that does not depart from the spirit of the present invention. Further, the individual components described in the claims and the specification can be arbitrarily combined or omitted within a range that allows them to remain capable of achieving at least a part of the above-described objects or producing at least a part of the above-described advantageous effects.

In the first embodiment, the motor instruction current calculation portion 90 in the electronic control unit 7 calculates the motor instruction current, and the motor control circuit 7g and the inverter circuit 76 control the electric motor 40 based on this motor instruction current. This configuration may be modified in such a manner that the target assist torque is calculated on the electronic control unit 7 side, and the motor control circuit 7g and the inverter circuit 76 control the electric motor 40 based on the calculated target assist torque.

In the first embodiment, in the processing performed by the electronic control unit 7 at the time of the sensor abnormality illustrated in FIG. 8, the electronic control unit 7 is configured to set the assist torque upper limit value Ta_limit, but may be configured to set an upper limit value on the motor instruction current corresponding to the assist torque upper limit value Ta_limit.

In the first embodiment, the electronic control unit 7 sets the assist torque upper limit value Ta_limit to the target assist torque Ta* in step S21 in the processing for gradually reducing the assist torque (FIG. 9) and step S31 in the Limp Home processing A (FIG. 10), but may be configured to set the assist torque upper limit value Ta_limit to an actually generated real assist torque.

In the first embodiment, the fail-safe processing portion 97 determines the processing to be selected according to the sensor where the abnormality has occurred. More specifically, the fail-safe processing portion 97 selects the processing for gradually reducing the assist torque when the abnormality has occurred in the steering angle sensor 5, and selects the Limp Home control when the abnormality has occurred in the steering torque sensor 4 or the motor rotational angle sensor 6. This configuration may be modified so as to select the processing for gradually reducing the assist torque when the abnormality has occurred in a sensor other than the steering angle sensor 5, and/or select the Limp Home control when the abnormality has occurred in a sensor other than the steering torque sensor 4 and the motor rotational angle sensor 6. Alternatively, the selection of each of the types of control may be made based on an abnormality in another configuration without being made based on the abnormality in the sensors.

In the following description, other configurations recognizable from the above-described embodiment will be described.

According to one configuration, provided is a control apparatus for a power steering apparatus configured to provide a steering force to a steering mechanism with use of an electric motor. The steering mechanism is configured to turn a turning target wheel according to a steering operation performed on a steering wheel. The control apparatus includes a torque signal reception portion configured to receive a signal of a steering torque generated on the steering mechanism, an instruction signal calculation portion configured to calculate an instruction signal for driving and controlling the electric motor based on the signal of the steering torque, and having characteristic information that increases the instruction signal as the steering torque increases, an assist limitation instruction signal reception portion configured to receive an assist limitation instruction signal for reducing power to be supplied to the electric motor, a characteristic information correction portion configured to correct the characteristic information in such a manner that the instruction signal according to the steering torque gradually reduces according to the reception of the assist limitation instruction signal by the assist limitation signal reception portion, and a drive power supply portion configured to supply drive power for driving the electric motor to the electric motor based on the instruction signal.

Therefore, due to the gradual reduction in the instruction signal, a driver can feel as if a steering reaction force gradually increases regardless of a steering condition. As a result, the control apparatus allows the driver to recognize assist limitation even immediately after the assist limitation instruction signal reception portion receives the assist limitation instruction signal. Therefore, the control apparatus can eliminate or reduce discomfort that the driver otherwise would feel at the time of the assist limitation.

According to a further preferable configuration, the control apparatus for the power steering apparatus includes an upper limit value setting portion configured to set an upper limit value on the instruction signal. The upper limit value setting portion gradually reduces the upper limit value on the instruction signal according to the reception of the assist limitation instruction signal by the assist limitation signal reception portion.

Therefore, due to the gradual reduction in the upper limit value on the instruction signal, the driver can feel an increase in a steering load even in a high steering load region. Therefore, the control apparatus allows the driver to recognize the assist limitation even in the high steering load region.

According to another preferable configuration, the characteristic information correction portion corrects the characteristic information by changing a gain for multiplying the characteristic information thereby.

Therefore, the control apparatus can correct a map while preventing or cutting down an increase in a data amount of the characteristic information.

According to another preferable configuration, the characteristic information correction portion corrects the instruction signal by multiplying the instruction signal calculated according to the characteristic information by the gain.

Because multiplying the instruction signal by the gain, the control apparatus can prevent or cut down an increase in a calculation load compared to when correcting the characteristic information.

According to another preferable configuration, the control apparatus for the power steering apparatus includes an upper limit value setting portion configured to set an upper limit value on the instruction signal. The upper limit value setting portion sets the upper limit value to the same value as the instruction signal when the assist limitation signal reception portion receives the assist limitation instruction signal.

Therefore, since immediately after the assist limitation starts, the steering load increases, and the driver can recognize the assist limitation.

According to another preferable configuration, a signal for lighting up a warning lamp mounted on a vehicle is output according to the reception of the assist limitation signal by the assist limitation signal reception portion.

Therefore, the control apparatus can directly notify the driver of the assist limitation by means of the lighting-up of the warning lamp in addition to an indirect notification of the assist limitation due to the increase in the steering load.

According to another preferable configuration, the control apparatus for the power steering apparatus includes a supply power limitation portion configured to set an upper limit value on the power to be supplied to the electric motor according to the reception of the assist limitation signal by the assist limitation signal reception portion. The drive power supply portion supplies the drive power for driving the electric motor to the electric motor based on a smaller one of the upper limit value set by the supply power limitation portion and the instruction signal corrected by the characteristic information correction portion.

The control apparatus can improve safety of the assist control of the power steering apparatus by, when assist limitation is exerted by the supply power limitation portion besides the assist limitation by the characteristic information correction portion, selecting the smaller one of the instruction signals corrected according to the upper limit values of both of them.

According to another preferable configuration, the characteristic information correction portion corrects the characteristic information by linearly gradually reducing the characteristic information.

Therefore, the control apparatus can smoothly increase the steering load, thereby eliminating or reducing an uncomfortable steering feeling due to the increase in the steering load.

According to another preferable configuration, the control apparatus for the power steering apparatus includes a vehicle speed signal reception portion configured to receive a signal of a vehicle speed. The characteristic information correction portion increases a time period during which the characteristic information is corrected as the vehicle speed increases.

As the vehicle speed increases, the change in the steering reaction force exercises a larger influence on the steering by the driver. Therefore, the control apparatus can eliminate or reduce the influence on the steering by the driver to thereby improve the safety when the vehicle is running, by increasing the time period during which the characteristic information is corrected as the vehicle speed increases.

According to another preferable configuration, the control apparatus for the power steering apparatus includes a steering frequency signal reception portion configured to receive a signal regarding a frequency of the steering operation. The characteristic information correction portion increases a time period during which the characteristic information is corrected as the steering frequency increases.

As the steering frequency increases, the change in the steering reaction force exercises a larger influence on the steering by the driver. Therefore, the control apparatus can eliminate or reduce the influence on the steering by the driver to thereby improve the safety when the vehicle is running, by increasing the time period during which the characteristic information is corrected as the steering frequency increases.

According to another preferable configuration, the characteristic information correction portion increases a time period during which the characteristic information is corrected as the steering torque increases.

As the steering torque increases, the change in the steering reaction force exercises a larger influence on the steering by the driver. Therefore, the control apparatus can eliminate or reduce the influence on the steering by the driver to thereby improve the safety when the vehicle is running, by increasing the time period during which the characteristic information is corrected as the steering torque increases.

Further, from another aspect, a power steering apparatus includes a steering mechanism configured to turn a turning target wheel according to a steering operation performed on a steering wheel, an electric motor configured to provide a steering force to the steering mechanism, a controller configured to drive and control the electric motor, a torque signal reception portion provided in the controller and configured to receive a signal of a steering torque generated on the steering mechanism, an instruction signal calculation portion provided in the controller, configured to calculate an instruction signal for driving and controlling the electric motor based on the signal of the steering torque, and having characteristic information that increases the instruction signal as the steering torque increases, an assist limitation instruction signal reception portion provided in the controller and configured to receive an assist limitation instruction signal for reducing power to be supplied to the electric motor, a characteristic information correction portion provided in the controller and configured to correct the characteristic information in such a manner that the instruction signal according to the steering torque gradually reduces according to the reception of the assist limitation instruction signal by the assist limitation signal reception portion, and a drive power supply portion provided in the controller and configured to supply drive power for driving the electric motor to the electric motor based on the instruction signal.

Therefore, due to the gradual reduction in the instruction signal, a driver can feel as if a steering reaction force gradually increases regardless of a steering condition. As a result, the power steering apparatus allows the driver to recognize assist limitation even immediately after the assist limitation instruction signal reception portion receives the assist limitation instruction signal. Therefore, the power steering apparatus can eliminate or reduce discomfort that the driver otherwise would feel at the time of the assist limitation.

According to a further preferable configuration, the controller includes an upper limit value setting portion configured to set an upper limit value on the instruction signal. The upper limit value setting portion gradually reduces the upper limit value on the instruction signal according to the reception of the assist limitation instruction signal by the assist limitation signal reception portion.

Therefore, due to the gradual reduction in the upper limit value on the instruction signal, the driver can feel an increase in a steering load even in a high steering load region. Therefore, the power steering apparatus allows the driver to recognize the assist limitation even in the high steering load region.

According to another preferable configuration, the characteristic information correction portion corrects the characteristic information by changing a gain for multiplying the characteristic information thereby.

Therefore, the power steering apparatus can correct a map while preventing or cutting down an increase in a data amount of the characteristic information.

According to another preferable configuration, the characteristic information correction portion corrects the instruction signal by multiplying the instruction signal calculated according to the characteristic information by the gain.

Because multiplying the instruction signal by the gain, the power steering apparatus can prevent or cut down an increase in a calculation load compared to when correcting the characteristic information.

According to another preferable configuration, the controller includes an upper limit value setting portion configured to set an upper limit value on the instruction signal. The upper limit value setting portion sets the upper limit value to the same value as the instruction signal when the assist limitation signal reception portion receives the assist limitation instruction signal.

Therefore, since immediately after the assist limitation starts, the steering load increases, and the driver can recognize the assist limitation.

According to another preferable configuration, the controller outputs a signal for lighting up a warning lamp mounted on a vehicle according to the reception of the assist limitation signal by the assist limitation signal reception portion.

Therefore, the power steering apparatus can directly notify the driver of the assist limitation by means of the lighting-up of the warning lamp in addition to an indirect notification of the assist limitation due to the increase in the steering load.

According to another preferable configuration, the controller includes a supply power limitation portion configured to set an upper limit value on the power to be supplied to the electric motor according to the reception of the assist limitation signal by the assist limitation signal reception portion. The drive power supply portion supplies the drive power for driving the electric motor to the electric motor based on a smaller one of the upper limit value set by the supply power limitation portion and the instruction signal corrected by the characteristic information correction portion.

The power steering apparatus can improve safety of the assist control of the power steering apparatus by, when assist limitation is exerted by the supply power limitation portion besides the assist limitation by the characteristic information correction portion, selecting the smaller one of the instruction signals corrected according to the upper limit values of both of them.

According to another preferable configuration, the characteristic information correction portion corrects the characteristic information by linearly gradually reducing the characteristic information.

Therefore, the power steering apparatus can smoothly increase the steering load, thereby eliminating or reducing an uncomfortable steering feeling due to the increase in the steering load.

According to another preferable configuration, the controller includes a vehicle speed signal reception portion configured to receive a signal of a vehicle speed. The characteristic information correction portion increases a time period during which the characteristic information is corrected as the vehicle speed increases.

As the vehicle speed increases, the change in the steering reaction force exercises a larger influence on the steering by the driver. Therefore, the power steering apparatus can eliminate or reduce the influence on the steering by the driver to thereby improve the safety when the vehicle is running, by increasing the time period during which the characteristic information is corrected as the vehicle speed increases.

The present application claims priority to Japanese Patent Application No. 2016-77856 filed on Apr. 8, 2016. The entire disclosure of Japanese Patent Application No. 2016-77856 filed on Apr. 8, 2016 including the specification, the claims, the drawings, and the abstract is incorporated herein by reference in its entirety.

### REFERENCE SIGN LIST

1 power steering apparatus
2 steering mechanism
7 electronic control unit (control apparatus) (controller)
7b main steering torque signal reception portion
7 (torque signal reception portion)
7g motor control circuit (drive power supply portion)
40 electric motor
76 inverter circuit (drive power supply portion)
90 motor instruction current calculation portion (instruction signal calculation portion)
97 fail-safe processing portion (assist limitation instruction signal reception portion)
98 characteristic information correction portion
99 limiter setting portion (upper limit value setting portion)
100 supply power limitation portion
102 warning lamp
103 steering frequency signal calculation portion (steering frequency signal reception portion)

1. A control apparatus for a power steering apparatus configured to provide, with use of an electric motor, a steering force to a steering mechanism configured to turn a turning target wheel according to a steering operation performed on a steering wheel, the control apparatus comprising:
a torque signal reception portion configured to receive a signal of a steering torque generated on the steering mechanism;
an instruction signal calculation portion configured to calculate an instruction signal for driving and controlling the electric motor based on the signal of the steering torque, the instruction signal calculation portion having characteristic information that increases the instruction signal as the steering torque increases;
an assist limitation instruction signal reception portion configured to receive an assist limitation instruction signal for reducing power to be supplied to the electric motor;
a characteristic information correction portion configured to correct the characteristic information in such a manner that the instruction signal according to the steering torque gradually reduces according to the reception of the assist limitation instruction signal by the assist limitation instruction signal reception portion; and
a drive power supply portion configured to supply drive power for driving the electric motor to the electric motor based on the instruction signal.

2. The control apparatus for the power steering apparatus according to claim 1, comprising an upper limit value setting portion configured to set an upper limit value on the instruction signal,
wherein the upper limit value setting portion gradually reduces the upper limit value on the instruction signal according to the reception of the assist limitation instruction signal by the assist limitation instruction signal reception portion.

3. The control apparatus for the power steering apparatus according to claim 1, wherein the characteristic information correction portion corrects the characteristic information by changing a gain for multiplying the characteristic information thereby.

4. The control apparatus for the power steering apparatus according to claim 3, wherein the characteristic information correction portion corrects the instruction signal by multiplying the instruction signal calculated according to the characteristic information by the gain.

5. The control apparatus for the power steering apparatus according to claim 1, comprising an upper limit value setting portion configured to set an upper limit value on the instruction signal,
wherein the upper limit value setting portion sets the upper limit value to the same value as the instruction signal when the assist limitation instruction signal reception portion receives the assist limitation instruction signal.

6. The control apparatus for the power steering apparatus according to claim 1, wherein a signal for lighting up a warning lamp mounted on a vehicle is output according to the reception of the assist limitation instruction signal by the assist limitation instruction signal reception portion.

7. The control apparatus for the power steering apparatus according to claim 1, comprising a supply power limitation portion configured to set an upper limit value on the power to be supplied to the electric motor according to the reception of the assist limitation instruction signal by the assist limitation instruction signal reception portion,
wherein the drive power supply portion supplies the drive power for driving the electric motor to the electric motor based on a smaller one of the upper limit value set by the supply power limitation portion and a power value indicated by the instruction signal calculated according to the characteristic information corrected by the characteristic information correction portion.

8. The control apparatus for the power steering apparatus according to claim 1, wherein the characteristic information correction portion corrects the characteristic information by linearly gradually reducing the characteristic information.

9. The control apparatus for the power steering apparatus according to claim 1, comprising a vehicle speed signal reception portion configured to receive a signal of a vehicle speed,
wherein the characteristic information correction portion increases a time period during which the characteristic information is corrected as the vehicle speed increases.

10. The control apparatus for the power steering apparatus according to claim 1, comprising a steering frequency signal reception portion configured to receive a signal regarding a frequency of the steering operation,
wherein the characteristic information correction portion increases a time period during which the characteristic information is corrected as the frequency of the steering operation increases.

11. The control apparatus for the power steering apparatus according to claim 1, wherein the characteristic information correction portion increases a time period during which the characteristic information is corrected as the steering torque increases.

12. A power steering apparatus comprising:
a steering mechanism configured to turn a turning target wheel according to a steering operation performed on a steering wheel;
an electric motor configured to provide a steering force to the steering mechanism; and
a controller configured to drive and control the electric motor,
wherein the controller includes
a torque signal reception portion configured to receive a signal of a steering torque generated on the steering mechanism,
an instruction signal calculation portion configured to calculate an instruction signal for driving and controlling the electric motor based on the signal of the steering torque, the instruction signal calculation portion having characteristic information that increases the instruction
signal as the steering torque increases, an assist limitation instruction signal reception portion configured to receive an assist limitation instruction signal for reducing power to be supplied to the electric motor,
a characteristic information correction portion configured to correct the characteristic information in such a manner that the instruction signal according to the steering torque gradually reduces according to the reception of the assist limitation instruction signal by the assist limitation instruction signal reception portion, and
a drive power supply portion configured to supply drive power for driving the electric motor to the electric motor based on the instruction signal.

13. The power steering apparatus according to claim 12, wherein the controller includes an upper limit value setting portion configured to set an upper limit value on the instruction signal, and
wherein the upper limit value setting portion gradually reduces the upper limit value on the instruction signal according to the reception of the assist limitation instruction signal by the assist limitation instruction signal reception portion.

14. The power steering apparatus according to claim 12, wherein the characteristic information correction portion corrects the characteristic information by changing a gain for multiplying the characteristic information thereby.

15. The power steering apparatus according to claim 14, wherein the characteristic information correction portion corrects the instruction signal by multiplying the instruction signal calculated according to the characteristic information by the gain.

16. The power steering apparatus according to claim 12, wherein the controller includes an upper limit value setting portion configured to set an upper limit value on the instruction signal, and
wherein the upper limit value setting portion sets the upper limit value to the same value as the instruction signal when the assist limitation instruction signal reception portion receives the assist limitation instruction signal.

17. The power steering apparatus according to claim 12, wherein the controller outputs a signal for lighting up a warning lamp mounted on a vehicle according to the reception of the assist limitation instruction signal by the assist limitation instruction signal reception portion.

18. The power steering apparatus according to claim 12, wherein the controller includes a supply power limitation portion configured to set an upper limit value on the power to be supplied to the electric motor according to the reception of the assist limitation instruction signal by the assist limitation instruction signal reception portion, and
wherein the drive power supply portion supplies the drive power for driving the electric motor to the electric motor based on a smaller one of the upper limit value set by the supply power limitation portion and a power value indicated by the instruction signal calculated according to the characteristic information corrected by the characteristic information correction portion.

19. The power steering apparatus according to claim 12, wherein the characteristic information correction portion corrects the characteristic information by linearly gradually reducing the characteristic information.

20. The power steering apparatus according to claim 12, wherein the controller includes a vehicle speed signal reception portion configured to receive a signal of a vehicle speed, and
wherein the characteristic information correction portion increases a time period during which the characteristic information is corrected as the vehicle speed increases.
